(19) United States
(12) Patent Application Publication
(10) Pub. No.: US 2026/0181071 A1
(43) Pub. Date: Jun. 25, 2026

(54) USER WARNING FOR FRAUDULENT CALL PHASES

(71) Applicant: McAfee, LLC, San Jose, CA (US)

(72) Inventors: Ayush Agarwal, Purnia (IN); Himanshu Srivastava, Bangalore (IN); Srikanth Nalluri, Bangalore (IN); Dattatraya Kulkarni, Bangalore (IN); Shashank Jain, Bangalore (IN); Sai Dattathrani, Bangalore (IN); Neha Sahoo, Kolkata (IN); Purushothaman Balamurugan, Salem (IN)

(21) Appl. No.: 19/542,475

(22) Filed: Feb. 17, 2026

Related U.S. Application Data
(63) Continuation-in-part of application No. 19/261,905, filed on Jul. 7, 2025.

(30) Foreign Application Priority Data
Jul. 9, 2024 (IN) 202441052535

(51) Int. Cl. H04M 3/22; H04M 3/42

(52) U.S. Cl. CPC H04M 3/2281; H04M 3/42042; H04M 2203/256; H04M 2203/6027

(57) ABSTRACT

A computer-implemented system, method, and apparatus for warning a user of fraudulent call phases may include communicating with a backend analysis engine, wherein the backend analysis engine is to provide a periodically-updated assessment of a voice call, the assessment comprising an inferred call phase and a fraudulence score; and providing a graphical user interface (GUI) visible to a participant of the voice call, wherein the GUI is to display the inferred call phase and a visual fraud indicator based on a likelihood that the voice call is fraudulent.

### CROSS REFERENCE TO RELATED APPLICATIONS

This application claims priority to Indian Provisional Application 202441052535, titled “Fraudulent Call Detection,” filed Jul. 9, 2024, which is incorporated herein by reference and claims priority to and is a continuation-in-part of U.S. application Ser. No. 19/261,905, filed Jul. 7, 2025, titled “Phased Fraudulent Call Detection.” Each of the following is incorporated herein by reference in its entirety.

### FIELD OF THE SPECIFICATION

This specification relates to the field of consumer security, and more particularly, though not exclusively, to a system and method for providing a user warning for fraudulent call phases.

### BACKGROUND

Fraudulent calls, including scams, phishing attempts, spam, and other deceptive practices, pose a significant concern for consumers. These calls can be inconvenient time wasters but also lead to serious consequences such as financial losses, compromised personal data, and online security vulnerabilities. The number of scam calls is increasing in both the United States and globally.

### BRIEF DESCRIPTION OF THE DRAWINGS

The present disclosure is best understood from the following detailed description when read with the accompanying FIGURES. It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion. Furthermore, the various block diagrams illustrated herein disclose only one illustrative arrangement of logical elements. Those elements may be rearranged in different configurations, and elements shown in one block may, in appropriate circumstances, be moved to a different block or configuration.

FIG. 1 is a block diagram of selected elements of a consumer protection ecosystem.

FIG. 2 is a block diagram of selected elements of a fraudulent call analysis system.

FIG. 3 is block diagram of selected elements of a call analysis pipeline.

FIG. 4 is a block diagram of selected elements of a phased telephone conversation.

FIG. 5 is a flow chart showing selected elements of a fraudulent call detection method.

FIG. 6 is a block diagram of selected elements of an illustrative UI element of a fraudulent call detection assistant.

FIG. 7 is a block diagram of selected elements of an illustrative UI element of a fraudulent call detection assistant.

FIG. 8 is a block diagram of selected elements of an illustrative UI element of a fraudulent call detection assistant.

FIG. 9 is a block diagram of selected elements of an illustrative UI element of a fraudulent call detection assistant.

FIG. 10 is a block diagram of selected elements of a user warning system.

FIG. 11 is a block diagram of selected elements of a system-on-a-chip (SoC).

FIG. 12 is a block diagram of selected elements of a network function virtualization (NFV) infrastructure.

FIG. 13 is a block diagram of selected elements of a containerization infrastructure.

FIG. 14 illustrates machine learning according to a “textbook” problem with real-world applications.

### SUMMARY

A computer-implemented system, method, and apparatus for warning a user of fraudulent call phases may include communicating with a backend analysis engine, wherein the backend analysis engine is to provide a periodically-updated assessment of a voice call, the assessment comprising an inferred call phase and a fraudulence score; and providing a graphical user interface (GUI) visible to a participant of the voice call, wherein the GUI is to display the inferred call phase and a visual fraud indicator based on a likelihood that the voice call is fraudulent.

### EMBODIMENTS OF THE DISCLOSURE

The following disclosure provides many different embodiments, or examples, for implementing different features of the present disclosure. Specific examples of components and arrangements are described below to simplify the present disclosure. These are, of course, merely examples and are not intended to be limiting. Further, the present disclosure may repeat reference numerals and/or letters in the various examples. This repetition is for the purpose of simplicity and clarity and does not in itself dictate a relationship between the various embodiments and/or configurations discussed. Different embodiments may have different advantages, and no particular advantage is necessarily required of any embodiment.

### Overview

One issue in any security context, including detection of fraudulent calls, is that detecting a threat by itself may not be sufficient to mitigate the threat. Some action must be taken in response to the threat. In the case of a fraudulent call detection ecosystem, there may be particular sensitivities because the consequences of overreaction can be inconvenient or even severe for a user. For example, terminating a genuinely fraudulent call may provide valuable protection for a user, but terminating a call from a prospective employer that is falsely detected as fraudulent may have serious consequences. Thus, a system may usefully provide user warnings that are less obtrusive when confidence is lower, and reactions may escalate as confidence increases.

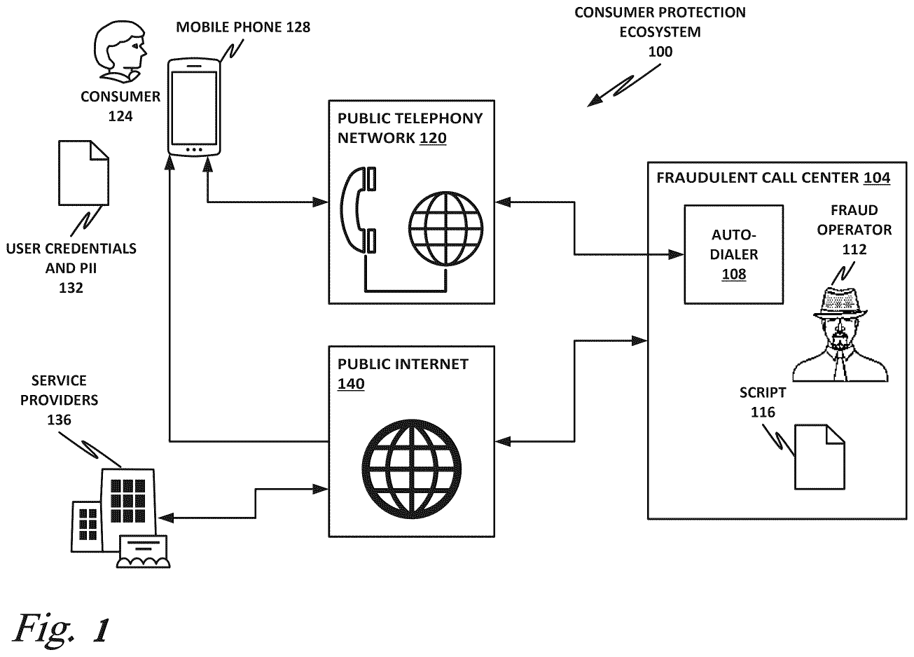

In one example, a backend service listens in on the call to provide an ongoing score and assess the probability that the call is fraudulent. Examples of such a system are provided in FIGS. 1-5 below. The backend system may then provide to a front-end display information about the call, including an assessment of whether the call is fraudulent, and if the call appears to be a marketing or fraud call, an assessment of the current phase of the call.

In an illustrative example of a fraudulent call, the fraudster first tries to establish credibility and trust with the caller, creates a sense of urgency or greed, and then gradually tries to gather sensitive information. The scam may be built around typical events for human users, and can generate a sense of greed and urgency by replicating recent user activities. This manipulative approach mailer victims into seemingly genuine scenarios, ultimately leading them to disclose sensitive information.

The present system provides a useful warning to the user by, in some embodiments, escalating notifications as the probability of fraud increases. At the beginning of a call, confidence in fraud may be low, and so the system may simply display a graphical user interface (GUI) with useful information about the call and the system's ongoing assessment of the probability of fraud. In some embodiments, the GUI may be substantially a full-screen GUI to ensure that the user can easily see it, and may be displayed only when there are indicia of potential fraud, such as in the case of unknown callers or other instances where fraud may be present.

As the call progresses, the backend system may continue to assess the call to determine whether indicia of fraud continue to be present. If so, the GUI continues to update the user. Various graphical elements may be present, such as a simulated analog meter that veers to the right as the probability of fraud increases, a prominent percentage score, a call “grade” (e.g., on an A-F scale, where a call with an A grade is deemed legitimate, and a call with an F grade is fraudulent), a color-coded display (green for “safe,” yellow for “warning,” and red for “danger” or “fraudulent”), a quantized simple value (e.g., “low,” “medium,” or “high” risk for the call).

As the probability of fraud increases (e.g., as the call enters new, known phases, and the system determines that the call is more likely fraudulent), the severity of the warning can also increase to match the threat. For example, below a first threshold (e.g., 70%), the GUI simply displays the information and provides warning. As the threat probability increases (e.g., over 70% or some other threshold), the warnings become more urgent. The system may escalate to providing haptic feedback (e.g., buzzing) if the user does not heed threat warnings. This may be a result of the user holding the phone to an ear, and thus not seeing the display and the escalating threat environment. The haptic feedback may get the user's attention and prompt the user to look at the screen, where the threat warning will be visible.

If the call continues beyond the haptic warning, an audible warning may also be included (e.g., between 70% and 80%). This could be, for example, a shrill alarm that gets the user's attention. Alternatively, an audible warning could include a recorded or AI-driven verbal warning, even in a mild tone: “Warning. This call has been detected as potentially fraudulent. For your safety, you should consider terminating this call.” Not only will this warn the target/potential victim, but it may also “spook” the fraudulent caller, prompting them to end the call.

In some cases where authorized, if the fraud probability reaches another threshold (e.g., above 80%), the system may autonomously terminate the call. Realistically, most cases may not reach this point, as most users will respond to the fraud warnings. Fraud calls rely essentially on catching users unwary. Anything that tips the user off to the danger is generally fatal to the call. However, a user can authorize the system (e.g., via a configurable control or permission) to terminate calls if the fraud probability goes beyond a given threshold.

This system may realize advantages over (and may supplement) existing solutions, which help users avoid scam calls by alerting them to incoming calls from known or suspected spam, scam, fraud, or untrustworthy numbers. Data about these numbers may be collected or crowd sourced from publicly available databases. However, fraudsters often rotate, recycle, or lease phone numbers temporarily, making it difficult for existing systems to keep up. This can allow recycled numbers to bypass current safeguards.

This disclosure also provides various embodiments for identifying fraudulent calls. These methods involve segmenting calls into short intervals, recognizing recurring patterns in fraudulent calls, detecting artificial voices (e.g., AI or pre-recorded), inferring the fraudster's intent, and offering real-time feedback in the course of a live conversation.

The present specification provides a solution for on-the-fly fraudulent call detection during an ongoing audio call or voice conversation. Upon analyzing an ongoing call and determining that it is likely fraudulent, the system may provide an advisory that enables the user to recognize potentially fraudulent or deceptive conversations. This empowers the user to make informed decisions and be less likely to be a victim of a scam.

Embodiments of the present specification provide progressive analysis of the ongoing conversation, offering feedback as the call progresses. The system may divide the conversation into short segments (e.g., each segment being a few seconds long, such as 10 to 30 seconds). After a few seconds of conversation, the system analyzes the content and assigns a rolling score to indicate the likelihood of fraud for that segment. As the conversation evolves, the system can gain increased confidence either that the call is genuine or that the call is fraudulent.

To improve confidence, the system considers scores from previous segments when evaluating the current one. This allows the system to understand the conversation's overall pattern and how fraud risk evolves.

Furthermore, the system analyzes conversation content and caller behavior. It may detect malicious behavior by comparing the conversation's progression to patterns common in fraudulent calls. For example, typical phases of a fraudulent call might include:
a. A first phase where the caller introduces himself and describes his purpose;
b. A second phase where the caller attempts to establish credibility by building trust and rapport.
c. A third phase where the caller exerts pressure through fabricated problems, false information, or appeals to sympathy, urgency, and greed.
d. A fourth phase involves the caller attempting to collect monetary account information, personally identifying information (PII), or other sensitive information.

Thus, detecting a fraudulent call involves identifying conversations that follow a multiphase pattern. The presence of this pattern itself can indicate fraudulent intent. Furthermore, the system can adapt as fraudsters modify their tactics. For example, they may introduce new phases or alter existing ones. In such cases, a machine learning (ML) system trained on a dataset of fraudulent calls can enhance ongoing detection.

The system disclosed herein may also pay attention to the victim's responses. The system assesses whether the victim seems gullible or easily tricked during conversation. The system may also watch for signs of confusion in the victim's responses, as this may indicate a higher risk of the victim falling for the scam. The system may also have access to a user profile, which can provide contextual information about the targeted caller, such as age, education level, business background, financial context, or other useful information. The user may provide this information voluntarily, or it may be inferred from public or other available records, as appropriate.

The foregoing can be used to build or embody several example implementations, according to the teachings of the present specification. Some example implementations are included here as nonlimiting illustrations of these teachings.

There is disclosed herein a system and method for detecting fraudulent call activity. Aspects of the method for detecting fraudulent activity on a user device involve segmenting an ongoing voice call between a user and a second party into discrete segments while the call is in progress. The method further includes analyzing respective discrete segments and assigning per-segment weighted fraud scores, where each weighted fraud score accounts for the weighted fraud score of a previous segment. Based on these per-segment weighted fraud scores, the method determines that the voice call is likely a fraudulent call. After making this determination, the method provides a human-perceptible warning to the user before the user discloses sensitive user data.

Additional aspects of the method include providing the human-perceptible warning in various forms, such as an audible, visual, or haptic warning. The voice call being analyzed can be an incoming voice call, and it may originate from an unknown phone number or a known phone number that is listed in the user's electronic address book or contact list.

The discrete segments of the voice call can be of equal length to one another or of variable length, with the variable length determined by breaks in speech. Analyzing each discrete segment can involve converting the segment to text and analyzing it via a large language model (LLM) to identify textual indicia of deceit. Alternatively, analysis may involve examining vocal cues of the second party to detect fake voice indicators or assessing vocal cues of both the user and the second party to identify indicia of heightened emotion.

Further aspects of determining that a voice call is likely fraudulent include identifying a multi-phase call structure common to fraudulent calls, which may comprise phases such as introduction and purpose, building credibility, applying pressure, and a payoff phase. The sensitive user data that the method aims to protect can include personally identifying information (PII), user credentials, account data, or money access.

Embodiments of an apparatus for performing these methods include means for segmenting the voice call, analyzing discrete segments, assigning weighted fraud scores, determining the likelihood of a fraudulent call, and providing warnings. Such an apparatus may comprise a processor and a memory, with the memory containing machine-readable instructions that, when executed, cause the apparatus to perform the method. The apparatus can be realized as a computing system, including various types such as desktop computers, workstations, laptop computers, notebook computers, netbooks, tablet computers, convertible tablet computers, smart phones (including Android phones and iPhones), Windows phones, or servers.

In some embodiments, the server may include a guest infrastructure to realize server functions, with this infrastructure potentially comprising virtualization or containerization. The computing apparatus can also be implemented as a gateway.

Computer-readable media can store instructions that, when executed, implement these methods or realize such apparatuses. These media can include tangible, nontransitory computer-readable storage media having stored thereon executable instructions to instruct a processor circuit to perform the method steps, including segmenting voice calls, analyzing segments for fraud indicators, and providing user warnings.

The computing apparatus comprises a hardware platform with a processor circuit and memory. The memory stores instructions that direct the processor circuit to segment ongoing voice calls into discrete parts. These parts are analyzed to assess the likelihood of fraudulent activity using weighted scores based on previous segments. The apparatus determines if a call is likely fraudulent and provides human-perceptible warnings before sensitive data disclosure.

Variations in the computing apparatus include differences in the type of human-perceptible warning provided (audible, visual, or haptic), the nature of the voice call (incoming, from known or unknown numbers), segment length (equal or variable based on speech breaks), analysis techniques (text conversion and LLM analysis, vocal cue examination for fake voices or heightened emotion), and the types of sensitive user data protected (PII, credentials, account data, money access).

The computing apparatus can take many forms, including desktop computers, workstations, laptops, notebooks, netbooks, tablets, convertible tablets, smartphones (including Android phones, iPhones, and Windows phones), servers with optional guest infrastructure for virtualization or containerization, and gateways. Each of these apparatuses can be configured to perform the method steps related to fraud detection during voice calls and provide appropriate warnings to protect user data.

### Selected Examples

The foregoing can be used to build or embody several example implementations, according to the teachings of the present specification. Some example implementations are included here as nonlimiting illustrations of these teachings.

There is disclosed herein an example of one or more tangible, nontransitory computer-readable storage media having stored thereon executable instructions to instruct a processor to communicate with a backend analysis engine, wherein the backend analysis engine is to provide a periodically-updated assessment of a voice call, the assessment comprising an inferred call phase and a fraudulence score; and provide a graphical user interface (GUI) visible to a participant of the voice call, wherein the GUI is to display the inferred call phase and a visual fraud indicator based on a likelihood that the voice call is fraudulent.

There is further disclosed an example, wherein the visual fraud indicator comprises a percentage.

There is further disclosed an example, wherein the visual fraud indicator comprises an A-F grade.

There is further disclosed an example, wherein the visual fraud indicator comprises a quantized indication of low, medium, or high.

There is further disclosed an example, wherein the visual fraud indicator comprises a color-coded indication.

There is further disclosed an example, wherein the color-coded indication comprises green for safe, yellow for risky, and red for likely fraudulent.

There is further disclosed an example, wherein the visual fraud indicator comprises a simulated analog meter.

There is further disclosed an example, wherein the visual fraud indicator flashes a warning above a fraud likelihood threshold.

There is further disclosed an example, wherein the fraud likelihood threshold is 70%.

There is further disclosed an example, wherein the instructions are further to terminate the voice call above a fraud likelihood threshold.

There is further disclosed an example, wherein the fraud likelihood threshold is 80%.

There is further disclosed an example, wherein the instructions are further to provide an audible warning above a fraud likelihood threshold.

There is further disclosed an example, wherein the audible warning is a shrill alarm.

There is further disclosed an example, wherein the audible warning is a voice prompt that a fraudulent call has been detected.

There is further disclosed an example, wherein the fraud likelihood threshold is between 70% and 80%.

There is further disclosed an example of a computer-implemented method of protecting a user of a device from fraudulent voice calls, comprising communicating with a backend analysis engine, wherein the backend analysis engine is to provide a periodically-updated assessment of a voice call, the assessment comprising an inferred call phase and a fraudulence score; and providing a graphical user interface (GUI) visible to a participant of the voice call, wherein the GUI is to display the inferred call phase and a visual fraud indicator based on a likelihood that the voice call is fraudulent.

There is further disclosed an example, wherein the visual fraud indicator comprises a percentage.

There is further disclosed an example, wherein the visual fraud indicator comprises an A-F grade.

There is further disclosed an example, wherein the visual fraud indicator comprises a quantized indication of low, medium, or high.

There is further disclosed an example, wherein the visual fraud indicator comprises a color-coded indication.

There is further disclosed an example, wherein the color-coded indication comprises green for safe, yellow for risky, and red for likely fraudulent.

There is further disclosed an example, wherein the visual fraud indicator comprises a simulated analog meter.

There is further disclosed an example, wherein the visual fraud indicator flashes a warning above a fraud likelihood threshold.

There is further disclosed an example, wherein the fraud likelihood threshold is 70%.

There is further disclosed an example, further comprising terminating the voice call above a fraud likelihood threshold.

There is further disclosed an example, wherein the fraud likelihood threshold is 80%.

There is further disclosed an example, further comprising providing an audible warning above a fraud likelihood threshold.

There is further disclosed an example, wherein the audible warning is a shrill alarm.

There is further disclosed an example, wherein the audible warning is a voice prompt that a fraudulent call has been detected.

There is further disclosed an example, wherein the fraud likelihood threshold is between 70% and 80%.

There is further disclosed an example apparatus comprising means for performing the method.

There is further disclosed an example, wherein the means for performing the method comprise a processor and a memory.

There is further disclosed an example, wherein the memory comprises machine-readable instructions that, when executed, cause the apparatus to perform the method.

There is further disclosed an example, wherein the apparatus is a computing system.

There is further disclosed an example of at least one computer readable medium comprising instructions that, when executed, implement a method or realize an apparatus as described.

There is further disclosed an example of a computing apparatus, comprising a hardware platform comprising a processor circuit and a memory; and instructions encoded within the memory to instruct the processor circuit to communicate with a backend analysis engine, wherein the backend analysis engine is to provide a periodically-updated assessment of a voice call, the assessment comprising an inferred call phase and a fraudulence score; and provide a graphical user interface (GUI) visible to a participant of the voice call, wherein the GUI is to display the inferred call phase and a visual fraud indicator based on a likelihood that the voice call is fraudulent.

There is further disclosed an example, wherein the visual fraud indicator comprises a percentage.

There is further disclosed an example, wherein the visual fraud indicator comprises an A-F grade.

There is further disclosed an example, wherein the visual fraud indicator comprises a quantized indication of low, medium, or high.

There is further disclosed an example, wherein the visual fraud indicator comprises a color-coded indication.

There is further disclosed an example, wherein the color-coded indication comprises green for safe, yellow for risky, and red for likely fraudulent.

There is further disclosed an example, wherein the visual fraud indicator comprises a simulated analog meter.

There is further disclosed an example, wherein the visual fraud indicator flashes a warning above a fraud likelihood threshold.

There is further disclosed an example, wherein the fraud likelihood threshold is 70%.

There is further disclosed an example, wherein the instructions are further to terminate the voice call above a fraud likelihood threshold.

There is further disclosed an example, wherein the fraud likelihood threshold is 80%.

There is further disclosed an example, wherein the instructions are further to provide an audible warning above a fraud likelihood threshold.

There is further disclosed an example, wherein the audible warning is a shrill alarm.

There is further disclosed an example, wherein the audible warning is a voice prompt that a fraudulent call has been detected.

There is further disclosed an example, wherein the fraud likelihood threshold is between 70% and 80%.

There is further disclosed an example, wherein the computing apparatus is a smart phone.

There is further disclosed an example, wherein the computing apparatus is an Android phone.

There is further disclosed an example, wherein the computing apparatus is an iPhone.

There is further disclosed an example, wherein the computing apparatus is a Windows phone.

There is further disclosed an example, wherein the computing apparatus is a desktop computer.

There is further disclosed an example, wherein the computing apparatus is a workstation.

There is further disclosed an example, wherein the computing apparatus is a laptop computer.

There is further disclosed an example, wherein the computing apparatus is a notebook computer.

There is further disclosed an example, wherein the computing apparatus is a netbook.

There is further disclosed an example, wherein the computing apparatus is a tablet computer.

There is further disclosed an example, wherein the computing apparatus is a convertible tablet computer.

There is further disclosed an example, wherein the computing apparatus is a server.

There is further disclosed an example, further comprising a guest infrastructure to realize server functions.

There is further disclosed an example, wherein the guest infrastructure comprises virtualization.

There is further disclosed an example, wherein the guest infrastructure comprises containerization.

There is further disclosed an example, wherein the computing apparatus is a gateway.

### DETAILED DESCRIPTION OF THE DRAWINGS

A system and method for providing user warnings for fraudulent call phases will now be described with more particular reference to the attached FIGURES. It should be noted that throughout the FIGURES, certain reference numerals may be repeated to indicate that a particular device or block is referenced multiple times across several FIGURES. In other cases, similar elements may be given new numbers in different FIGURES. Neither of these practices is intended to require a particular relationship between the various embodiments disclosed. In certain examples, a genus or class of elements may be referred to by a reference numeral (“widget 10”), while individual species or examples of the element may be referred to by a hyphenated numeral (“first specific widget 10-1” and “second specific widget 10-2”).

FIG. 1 is a block diagram of a computer consumer protection ecosystem 100. The ecosystem includes a consumer 124 operating a mobile device 128. Consumer 124 has access to user credentials and PII 132, which may include, for example, banking information, passwords, social security numbers, and electronic access to money, accounts, and services. These data points are examples of “sensitive user data” encompassed within PII 132.

A fraudulent call center 104 may employ multiple fraud operators 112 who contact users via an autodialer 108. The autodialer operates on the public telephone network 120 to call mobile phones 128, allowing fraud operators 112 to speak with users (e.g., consumers 124). Fraud operators 112 may attempt to gain access to PII 132 by contacting consumers 124 via mobile phone 128. During a call, fraud operators 112 may use a script 116 to guide their interactions with consumers 124 and ultimately obtain PII 132.

Consumer 124 may possess varying levels of wariness or sophistication. A well-trained or highly suspicious consumer 124 might recognize fraudulent call characteristics and avoid PII loss. Conversely, a less sophisticated or more gullible consumer 124 could be susceptible to fraud operator 112 using script 116 to gain access to PII 132.

A consumer 124 subscribes to a protection service provided by service provider 136). The service provider 136 may be a security services provider, such as McAfee or another suitable alternative. A mobile phone 128 accesses service provider 136 via the public internet 140. Service provider 136 may offer a cloud-based service that complements local computing on mobile phone 128.

When autodialer 108 places a call to mobile phone 128 through the public telephone network 120, software on mobile phone 128 may recognize that the call is coming from an unknown or untrusted number. Even if the number does not have a crowd-sourced known fraudulent reputation, the software may recognize that consumer 124 may be in danger of a fraudulent call. In this case, mobile phone 128 may operate its consumer protection engine to analyze the call for indicia of fraud or deceit. In some cases, the protection engine may operate even if the incoming phone number is in the user's contact list or phone book. Some frauds are “long cons,” in which the fraudster tries to gain trust over time, and thus may have previously contacted the user. Furthermore, even supposedly-trusted contacts, such as family members or alleged friends may try to take advantage of vulnerable users, such as elderly or disabled users. In some cases, a sensitivity level can be selected as a user option, to provide a tradeoff between protection and false positives. In other cases, a sensitivity level may be suggested based on the user's inherent risk profile (e.g., age, background, education, or similar).

The call analysis may occur in real-time during the call to identify fraudulent intent and warn the user (consumer 124) before personally identifiable information (PII) 132 is compromised. Mobile phone 128 may access service provider 136 via public Internet 140 to enhance its local analysis, such as by using deep neural networks (DNN), large language models (LLM), or other services not practical to run on mobile phone 128. If mobile phone 128 determines that the call is likely fraudulent, it may provide a warning to consumer 124 (e.g., visible, audible, and/or haptic), autonomously terminate the call under certain configurations, or take other remedial action against fraudulent call center 104.

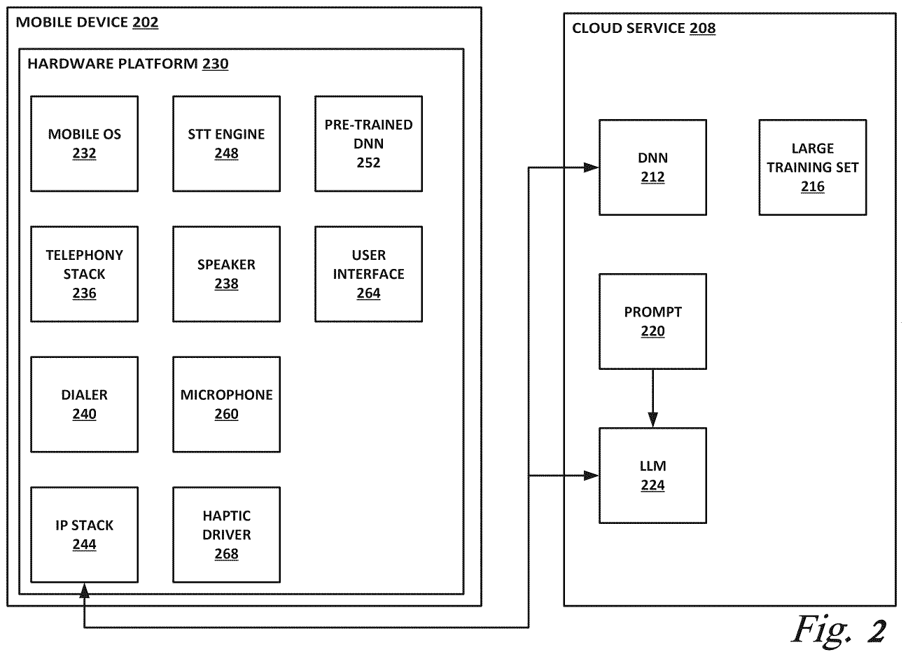

FIG. 2 is a block diagram of selected elements of a fraudulent call analysis ecosystem 200. Fraudulent call analysis ecosystem 200 may operate with a mobile device 202, running on a hardware platform 230. Hardware platform 230 provides the necessary hardware, firmware, and software services to interact with a human user.

Hardware platform 230 includes a mobile operating system 232, which may be for example Android, iOS, Windows mobile edition, or any other suitable operating system for mobile device 202.

A telephony stack 236 provides the hardware and software to interact with a public telephone network, such as a cellular or digital communication network. This may include, for example, a mobile telephone transceiver and software to make voice calls. A dialer 240 may include hardware and software to place outgoing calls to the mobile telephone network. Telephony stacked 236 also has the capacity to receive incoming calls.

An Internet Protocol (IP) stack 244 may include TCP/IP services to communicate with the Internet and with network-based services. IP stack 244 may provide a connection to cloud service 208, which may provide some supplemental services.

Mobile device 202 may also include a speech-to-text (STT) engine 248. STT engine 248 may convert ongoing calls to text in real-time or near-real-time, enabling processing by a large language model (LLM).

A speaker 238 provides an interface for the human user to hear calls and can be manipulated by security agent 270 to deliver audible warnings if the call is suspected to be a scam.

Microphone 260 provides user input to the call, and can be used as an interface to provide call data to STT engine 248 of security agent 270.

A haptic driver 268 may provide haptic feedback, such as a buzz or shake, if the security agent 270 suspects a scam call.

Security agent 270 may include a pre-trained DNN, which can detect scam calls by recognizing known phases of a scam. Pre-trained DNN 252 can interoperate with cloud services 208, providing access to a larger and more featureful DNN 212. Security agent 270 may also interface with an LLM 224 using a prompt 220 to help detect voice authenticity and scam-like behavior. Both DNN 212 and LLM 224 can be trained on a large training set 216.

A user interface 264 within security agent 270 may provide visual representations of the call status and analyze its legitimacy. Security agent 270 may launch user interface 264 under uncertain conditions, such as calls from unknown or untrusted numbers.

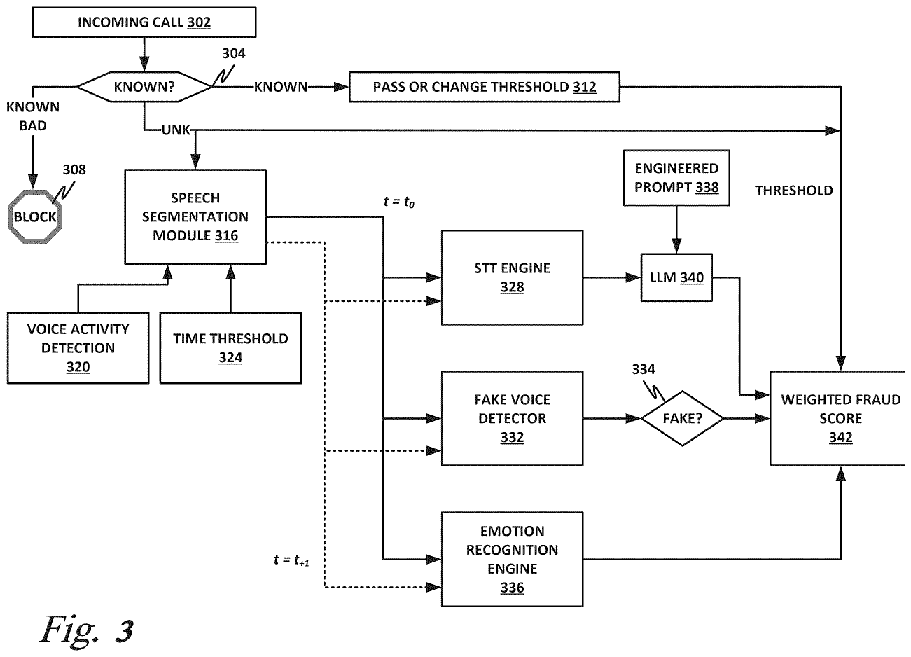

FIG. 3 is a block diagram of a processing pipeline 300 for a consumer protection ecosystem. Processing pipeline 300 starts with an incoming call 302.

In decision block 304, the system determines whether the caller is known. Notably, the fact that the incoming call is from a person with a known telephone number (e.g. in the user's contacts list) does not necessarily imply that the caller is trustworthy. One benefit of the present specification is that fraudulent or high-pressure tactics can be detected even from known callers. Some users can be defrauded even by supposedly trusted friends or family members. However, in some embodiments a user may prefer not to screen every call, and may elect to greenlight certain highly trusted callers such as a spouse, immediate family members, or highly trusted advisors. In other embodiments, greenlighting may not be provided, as even trusted confidants can abuse their positions to defraud the user.

If a caller is greenlit due to a known good reputation (block 312), they may receive an initial pass, which can be factored into the weighted fraud score (342). In some cases, the system may use heuristics to adjust the threshold for a caller over time. Callers with a history of trustworthy interactions may have a higher detection initiation threshold compared to other callers.

If the incoming call originates from a known malicious, fraudulent, scam, or phishing phone number in block 304, then in block 308 the call may be directly blocked without requiring further interaction.

Greater machine intelligence may be applied in cases where the caller has an unknown or untrusted (but not known bad) reputation. In this case, the unknown reputation may be provided as an initial value for a weighted fraud score 342, indicating that the caller is simply unknown.

Fraudulent call detection begins with a speech segmentation module 316. Speech segmentation module 316 samples the conversation in real time at intervals of t seconds and then processes the conversation using content analysis, fake voice detection, emotion recognition, and other processing steps. In various embodiments, t may be selected to provide both reasonable responsiveness and large enough segments to be useful. In some embodiments, t may be between 3 and 10 seconds seconds or between 3 and 30 seconds.

A time threshold 324 determines the speech segmentation module 316's sampling period. In some embodiments, the time threshold 324 is dynamic and influenced by voice activity detection 320. For example, during pauses or low conversation density, voice activity detection 320 may extend the time threshold 324 to capture more useful information.

Speech Segmentation Module 316 samples the conversation in real time at intervals of T seconds and then processes the conversation using content analysis, fake voice detection, emotion recognition engine 336.

STT engine 328 converts the speech segment to text that is usable by an LLM 340. LLM 340 receives the content of the transcribed speech segment, (which may be tagged according to voices, so that LLM 340 can differentiate between the caller and the callee). An engineered prompt 338 instructs LLM 340 to analyze the speech segment and use contextual information from the conversation to analyze the call for indicia of fraud. The context may include, for example, the identity of the caller, whether the caller is known or unknown, a profile of the callee (which may provide indicia of vulnerability or gullibility), time of day, and other contextual information. Engineered prompt 338 may also instruct the LLM 340 to analyze each segment of the conversation and generate a fraud score for each segment. LLM 340 may receive the call segments and rolling updates, so that it is aware of the full content and context of the call throughout the operation.

LLM 340 may also be directed to extract the intent of the caller from the conversation by using progressive analysis of the ongoing conversation. LLM 340 may aid in detecting the current phase of the conversation based on the following factors by way of illustrative and nonlimiting example:
a. The reason behind the call;
b. Whether the caller is trying to build credibility;
c. Whether the caller is generating a sense of greed and urgency;
d. Whether the caller is seeking PII or money, or if they are trying to create a scenario like the last day an offer is available, an artificial deadline, or threatening imminent financial loss as means of pressuring the callee.

LLM 340 may respond to engineered prompt 338 by creating a structured output. The structured output may include:
a. Caller details (e.g., whether the caller is known, and any known reputation);
b. Caller intent—the inferred intent of the caller;
c. Fraud score—an LLM-generated fraud score for each conversation segment. Labeled FS1 (fraud score 1), FS1 is input to weighted fraud score 342. FS1 may have a range such as 0% to 100%, 0 to 10, or 0 to 1.

Fake voice detector 332 may analyze the call segment to determine whether the caller's voice appears to be fake (e.g., pre-recorded or AI generated). A prerecorded or AI generated caller can be a strong indication of a robocall, with much higher likelihood of having fraudulent intent.

In decision block 334, the fake voice detector 332 determines if the caller's voice appears fake and provides a fraud score (FS2). FS2 can be a simple Boolean value (e.g., 0 for genuine and 1 for fake, or vice versa). A “fake” designation as 1 may be useful because it numerically increases a composite fraud score.

Emotion recognition engine 336 uses a DNN (local and/or remote) to detect emotions of both the caller and callee. This can help determine if either party is tense, if a high-pressure or high-emotion situation is developing, and if the situation may affect the callee's judgment. Emotion recognition engine 336 provides a fraud score (FS3). A final weighted fraud score (342) combines FS1, FS2, and FS3 using methods such as summation, multiplication, bucketized values, or other weighting/combination algorithms.

Weighted fraud score 342 in some embodiments may be displayed as a fraud indicator on a graphical user interface.

As illustrated in FIG. 3, after time t=t0, the system feeds back weighted fraud score 342 and analyzes the speech segment at t=t+1. Weighted fraud score 342 may be a rolling score updated as the conversation progresses.

The system may use weighted fraud score 342 to provide user advice based on the conversation. LLM 340 may generate human-readable plaintext recommendations for responding to the call, such as hanging up, asking follow-up questions if the call seems legitimate, or offering other appropriate advice.

Processing pipeline 300 goes beyond simple keyword spotting and blocking known spam phone numbers. Keywords can be modified over time, and phone numbers can be spoofed or changed frequently. Processing pipeline 300 leverages generative AI (GAI) to analyze conversations and the speaker's intent to identify fraudulent calls.

The system and method monitor calls from start to finish, progressively determining the fraud score. This prevents false alerts based on only the initial seconds of a call, when fraud detection may be premature. However, the system can alert the recipient during the call (e.g., before Personally Identifiable Information is compromised), enabling them to take appropriate remedial action as necessary . . . . The present system may update the weighted fraud score 340 as the call progresses, providing users with timely alerts. User interfaces may offer in-call advisories and audible, haptic, or visual warnings if fraud is detected.

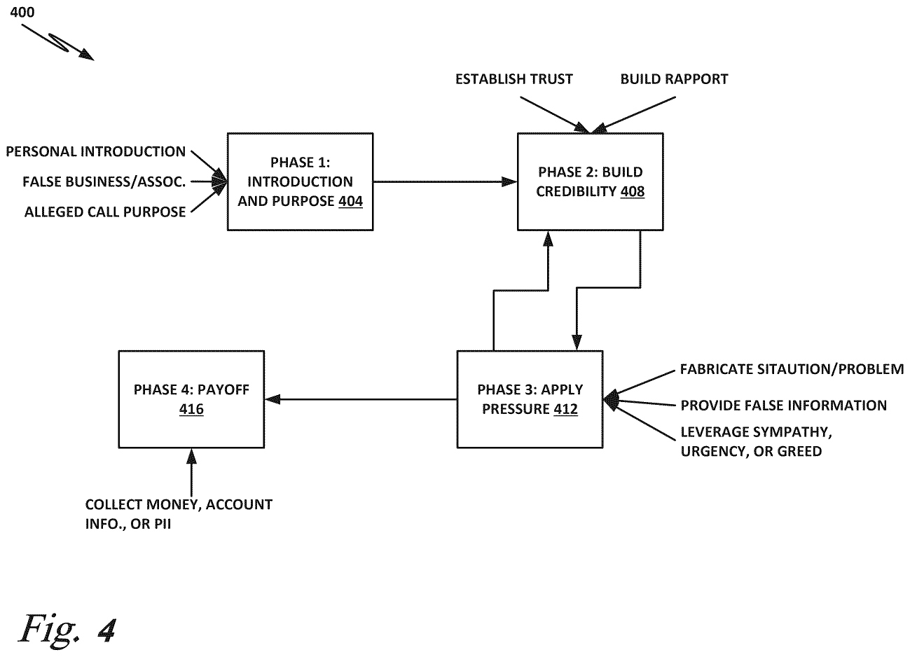

FIG. 4 is a block diagram of a phased phone conversation 400. Phased conversation 400 illustrates various phases of a potentially fraudulent call.

Phase 1 404 includes an introduction and stated purpose. The caller may introduce themselves, present a potentially false business or affiliation, and state the call's purpose. For example, the caller might say, “Hi, my name is Mike Jones. I'm calling from the Beneficial Association for Fallen State Troopers. We provide scholarships to children of peace officers killed in the line of duty. I was hoping you could give me a few minutes to discuss how you might help these families.”

In phase 2 408, the caller may attempt to establish credibility with the callee. This may involve providing false credentials, fabricating a backstory (e.g., “This cause is very important to me because I am the son of a fallen state trooper. My father was killed on State Highway 306 . . . ”), or pretending to share common ground with the callee to foster a trusting relationship.

In phase 3, 412, the caller may apply pressure. For example, they might fabricate a situation or problem (e.g., “Johnny Simmons just applied and got accepted to three top universities, but his mom calls me every night crying because she doesn't know how she's going to pay for it”). The caller may also provide false information, leverage sympathy, urgency, or greed. For example, in a stock scam, they might say, “This investment opportunity will not last. I am only authorized to offer you this opportunity if you lock in today.”

In phase 4 416, if the scammer is successful, they receive a payoff. This may include collecting money, account information, or other personally identifiable information (PII) or sensitive user data.

The four-phase structure is detectable, and many scam or fraud calls follow a similar structure. The presence of this structure may indicate fraudulent intent.

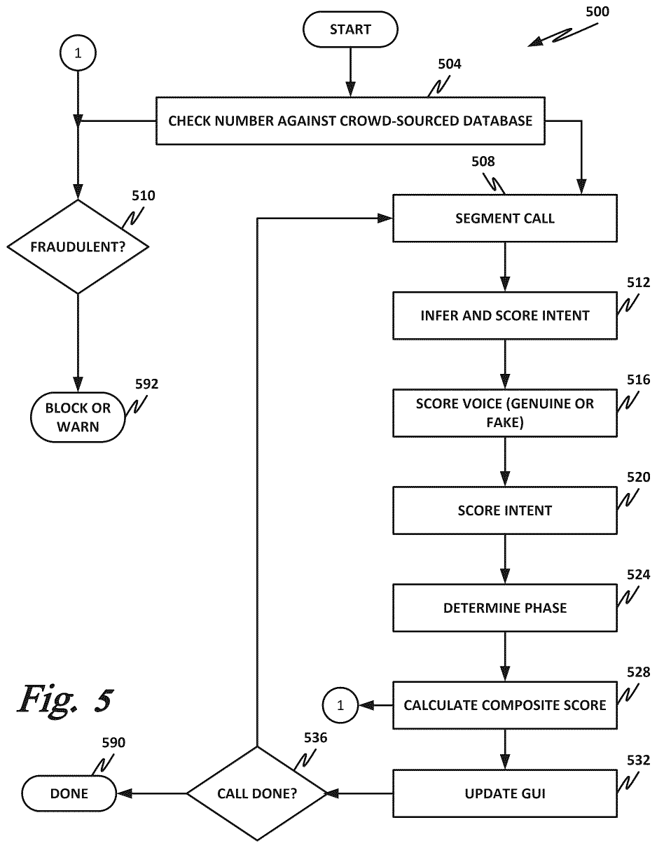

FIG. 5 is a flowchart of a method 500 of analyzing an ongoing call (or completed phone call as appropriate, e.g., in the case of a “post-mortem” analysis of a call).

Beginning at block 504, an incoming call is received. The system then checks the incoming phone number against a crowd-sourced database of known phone numbers.

In decision block 510, the system determines if the call originates from a known or suspected fraudulent source.

If the call originates from a known or suspected fraudulent source, terminal block 592 warns the user and/or blocks the call. Upon termination of the call, the method concludes for that phone call.

Returning to decision block 510, if the number is not identified as fraudulent or was not found in a known database of trusted or untrusted phone calls (from decision block 504), the method proceeds.

In block 508, the system segments the call using a fixed or dynamic segment length.

In block 512, the system infers and scores the call's intent using GAI analysis.

In block 516, the system scores the voice for genuineness. If the caller appears to be a genuine human but uses an artificially ingratiating or supplicating tone, the voice may be contextually fake because the human is not speaking with genuine intent.

In block 520, voice data is converted to text. An LLM then analyzes the text of the ongoing conversation to determine the caller's intent within the specific call segment.

In block 524, the system determines if the call follows a known multiphase fraudulent call structure (e.g., a four-phase structure). If so, it identifies the call's current phase.

In block 528, the system calculates a composite score for fraud or genuineness.

Following on-page connector 1 back to decision block 510, if the system determines with high confidence that the call is fraudulent, the system may block, terminate, or warn the user in block 592. If the system determines with intermediate confidence that the call may be fraudulent, the system may warn the user without terminating the call. If a high confidence fraud determination is not made in block 510, control returns to block 508 to analyze the next segment of the call.

Returning to block 528, the composite score for the current call segment is calculated. In block 532, the system updates a graphical user interface, displaying call information to the user.

If the call is not complete, the method proceeds to block 508 in decision block 536 and analyzes the next segment of the call.

If the call is complete, the method ends at block 590.

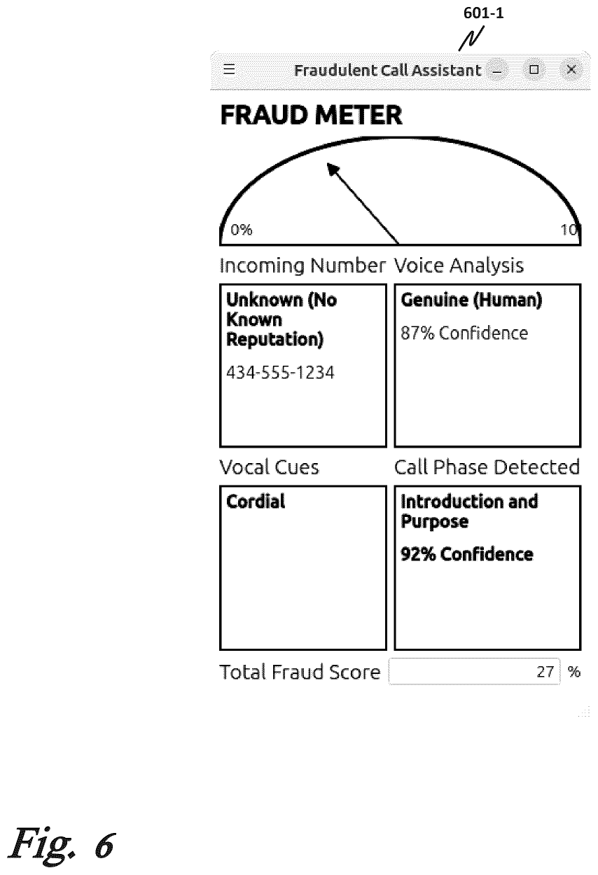

FIG. 6 is a block diagram illustration of selected elements of a graphical user interface. In this case, a fraudulent call assistant 601-1 is provided as a substantially full-screen interface to inform the user of the possibility of a fraudulent call.

Prominently displayed at the top of the fraudulent call assistant 601-1 is a fraud meter. In this case, the fraud meter appears as a simulated analog meter that veers further to the right as the probability of fraudulent increases. To provide further clarity, at the bottom of the screen is a total fraud score display, which currently displays a 27% probability that the call is fraudulent.

Several features may play into this probability of fraudulence. For example, the fraudulent call assistant includes several prominent and easily readable display blocks. These include information about the incoming number, a voice analysis, an analysis of vocal cues, and a current call phase if one is detected.

In this particular instance, the incoming call is from an unknown number with no known reputation. In other words, the caller may not be in the user's address book, and this number has not previously been indexed as a fraudulent phone number. Thus, the number is shown as having no known reputation. In some examples, this block may be color-coded, such as yellow in this case to indicate that information about the incoming caller is not known. If the caller were known and had a good reputation, the box could be green, and if the call came from a known fraud number, the box could be red. In that case, the fraud meter may be much higher, with a warning that the call should not be answered.

The second box is a voice analysis box. In this case, the system analyzes voice to determine whether it is likely a human voice, or if it is a digitally-rendered or AI voice. The type of voice is not a per se indicator of fraudulence, but may be a factor that is considered with other factors. For example, call centers often use robo-dialers and prerecorded messages to get a user started, before switching a hooked user to a human actor to complete the call. In this example, the system is 87% confident that the voice is a genuine human voice.

The third box indicates vocal cues. Vocal cues can be used to determine the caller's intent and in some cases may be combined with an AI-inferred intent via a large language model (LLM). Vocal cues can rely on both the content of the spoken word and on the tone of voice and other indicia of fraud such as strain or indicia of deceit. Again, the fact that the caller is trying to ingratiate himself does not necessarily indicate fraud, but may be a factor that is considered in connection with other factors.

Finally, the system determines whether it has detected an apparent call phase. For example, fraudulent calls may follow the four-phase structure disclosed in the specification. The fact that a call follows that structure may be another indicator of fraudulence. In this case, the system is 92% confident that the caller is currently in the introduction and purpose phase of the call.

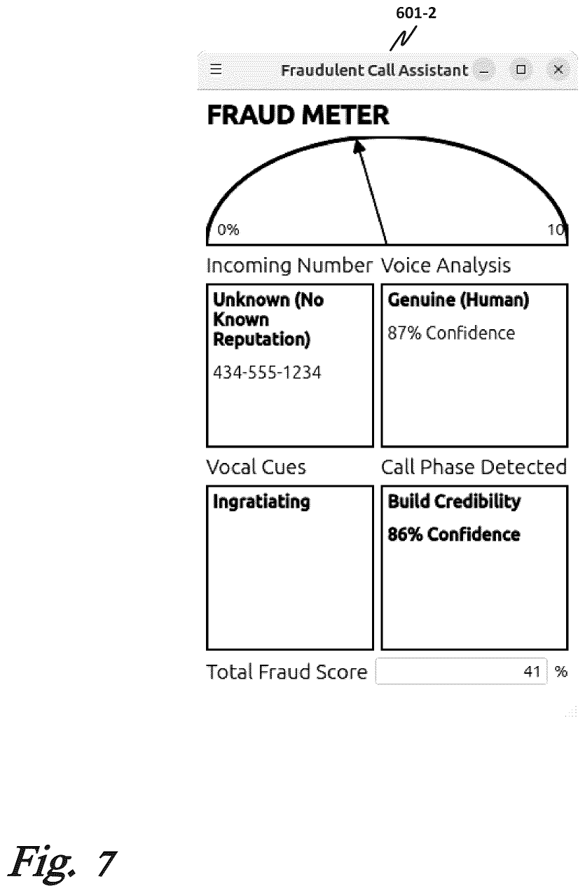

Turning to FIG. 7, fraudulent call assistant 601-2 is disclosed. In this case, the call has further progress. The number is still unknown, and the system is still 87% confident that the voice belongs to a genuine human speaker. However, the vocal cues have changed. The caller is now behaving in an ingratiating manner, which may be part of a new call phase such as a build credibility phase. In this case, the system is 86% confident that the caller has progressed to a build credibility phase of the call. This, combined with the ingratiating tone, and the fact that this is still an unknown number, increases the total fraud score to approximately 41%. This value is displayed prominently at the bottom, and the prominent fraud meter at the top has been moved accordingly.

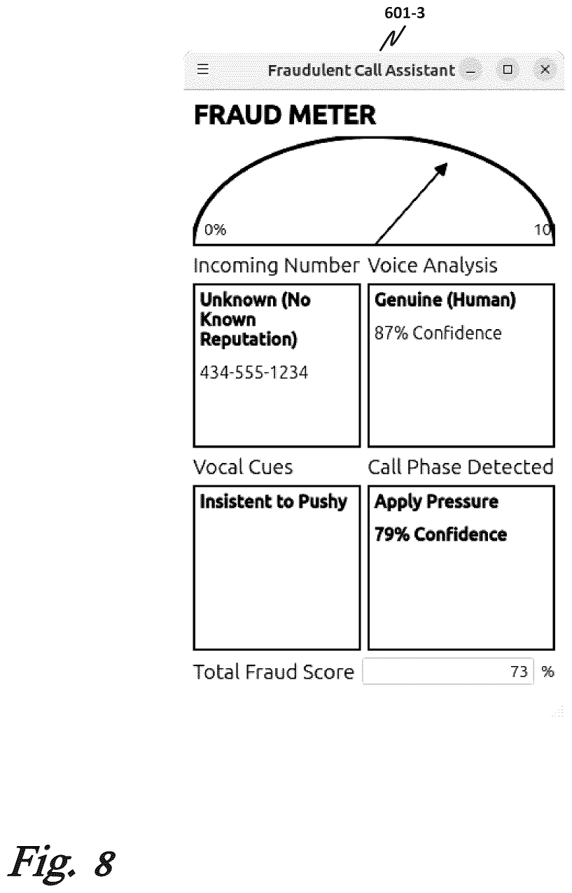

FIG. 8 illustrates a fraudulent call assistant 601-3. In this case, the call has progressed to a new phase. The number is still unknown, and the system is still 87% confident that the voice belongs to a genuine human input. However, the vocal cues are now insistent or pushy. This correlates to the new call phase of applying pressure. The system is 79% confident that the call has progressed to an applying pressure phase. The fact that the call has formulaic Lee followed the fraudulent call pattern is further indication of fraudulent intent. In this case, the total fraud score is now 73%, and the prominent simulated analog fraud meter has been moved accordingly.

Furthermore, because the call is ongoing, the user has not responded to the escalating information from the backend system. Thus, the display may be further modified to provide a more urgent warning. For example, fraudulent call assistant 601-3 may begin flashing red in the background or otherwise providing a visual cue to get the user's attention. Furthermore, above the 70% threshold (or at some other appropriate threshold), the system may provide haptic feedback that may prompt the user to look at the screen. The user may have been speaking with the phone to his or her ear, and thus may not have noticed the warnings from fraudulent call assistant 601. The haptic feedback will prompt the user to look at the phone, and see that the confidence of fraud has greatly increased.

Furthermore, the call may be above a second threshold (e.g. between 70% and 80%) such that vocal cues may also be provided. A shrill alarm may sound to warn the user of fraudulent intent, or even a calm but firm voice may verbally warn that a fraudulent call has been detected. Because both the user and the fraud caller will hear this warning, both may react accordingly. The user may determine that it is time to terminate the call, and the fraudulent caller may determine that his efforts have failed and it is time to hang up.

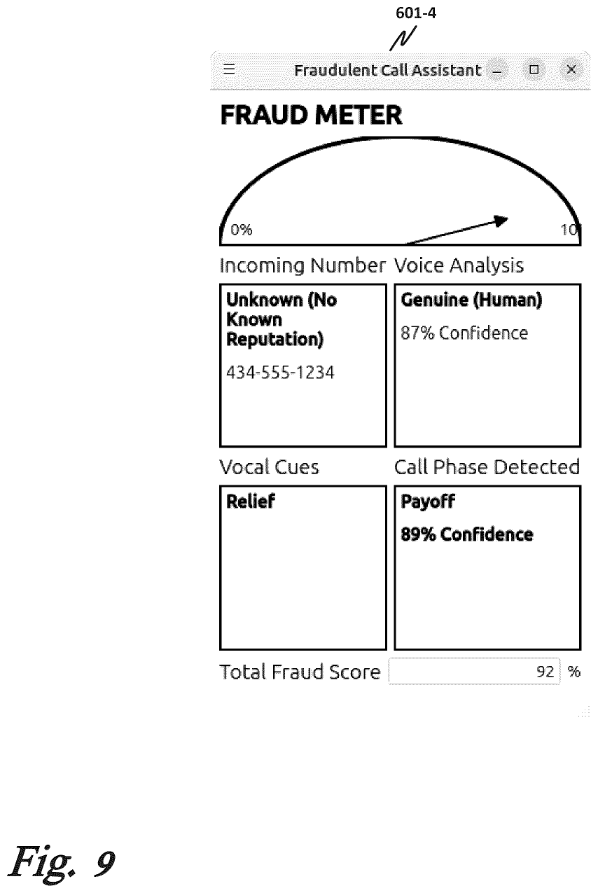

FIG. 9 is an illustration of fraudulent call assistant 601-4. At this point, the call has greatly progressed. The system still does not know the number's reputation, and is 87% confident that the speaker is a genuine human. However, because the fraud operator has entered the payoff phase (wherein he expects to receive value for his fraudulent efforts), his vocal cues may indicate relief. In this case, the system is 89% confident that the call has entered a payoff phase of a fraudulent interaction. The total fraud score has now risen to 92%. At this time, the system may take more urgent measures. For example, the system may provide additional haptic or audible feedback. Furthermore, in some embodiments, the system may not progress to this 92% point. If the user has provided sufficient permissions, the fraudulent call assistant may autonomously terminate the call at some threshold of confidence, such as 80% or 90% confident that the call is fraudulent. Thus, the call may be terminated before the payoff phase is perfected or before the consequences are irrevocable (e.g., when the user has actually provided money, bank account information, passwords, or other compromising information).

The fraudulent call assistant illustrated in FIGS. 6-9 may usefully escalate its responses in accordance with the escalation of danger. When danger is relatively low, the responses are relatively mild. The user may be warned that it is possible that the call is fraudulent, but it may still have a legitimate purpose and there is less urgency. As the system becomes more confident that the call is fraudulent, the system increases the urgency of its warnings, and if authorized, eventually terminates the call so that the user does not suffer harm.

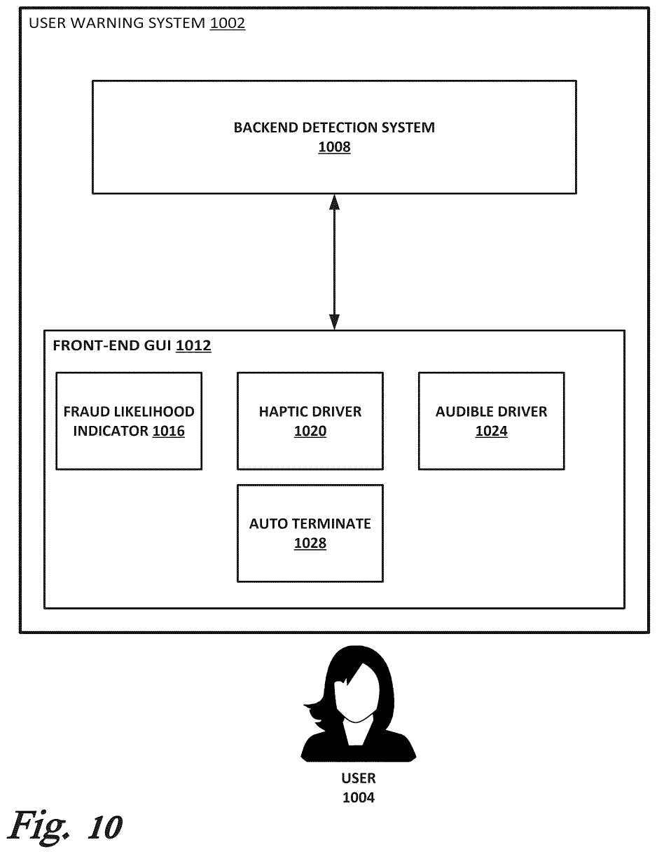

FIG. 10 is a block diagram of selected elements of a user warning system 1002, intended to assist user 1004. User warning system 1002 include a background detection system 1008, which may include some or all of the elements illustrated in FIGS. 1-5 of the present specification. This may include appropriate backend processing, interaction with cloud services, AI services such as LLMs, and other interactions that may usefully provide an assessment of whether a call is potentially fraudulent. The backend system may also communicate a confidence indicator (e.g., normalized between 0 and 1, a percentage, or a raw score) of whether the call is fraudulent, and an inferred phase of the call as appropriate. These data may be communicated to a front-end GUI 1012. Front-end GUI 1012 may include various elements to inform the user of the ongoing nature of the call. This may include a fraud likelihood indicator 1016. Fraud likelihood indicator 1016 may be, for example, a simulated analog meter, a prominent percentage display, a quantized display of {low, medium, high}, a call grade (on scale A-F), a color-coded display ({green, yellow, red}, indicating progressive levels of danger), or any other useful fraud likelihood indicator.

A haptic driver 1020 may trigger above certain thresholds, such as above 70%. Haptic feedback may prompt a user who has not seen fraud warnings to look at the phone's display.

An audible driver 1024 may trigger at the same or different thresholds, such as some value between 70% and 80%. Audible driver 1024 may provide an alarm, a spoken warning, or any other audible cue that may get the user's attention.

Where authorized by user permissions, auto-terminate 1028 can autonomously terminate the call when appropriate, such as when the fraud likelihood has gone above a certain percentage such as 80% or 90%.

User warning system 1002 may thus combine a backend processing with a front-end display to better protect user 1004.

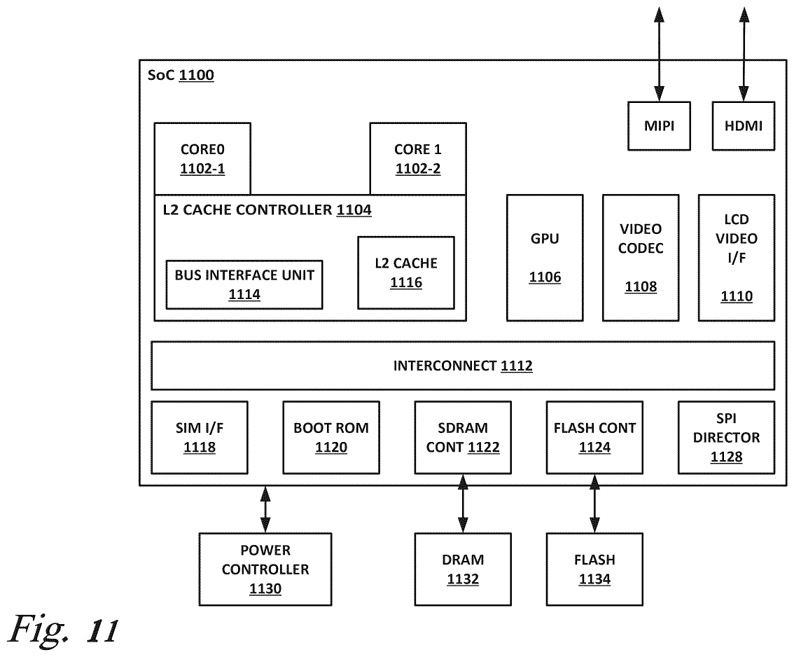

FIG. 11 is a block illustrating selected elements of an example SoC 1100. At least some of the teachings of the present specification may be embodied on an SoC 1100, or may be paired with an SoC 1100. SoC 1100 may include, or may be paired with, an advanced reduced instruction set computer machine (ARM) component. For example, SoC 1100 may include or be paired with any ARM core, such as A-9, A-15, or similar. This architecture represents a hardware platform that may be useful in devices such as tablets and smartphones, by way of illustrative example, including Android phones or tablets, iPhone (of any version), iPad, Google Nexus, Microsoft Surface. SoC 1100 could also be integrated into, for example, a PC, server, video processing components, laptop computer, notebook computer, netbook, or touch-enabled device.

SoC 1100 may include multiple cores 1102-1 and 1102-2. In this illustrative example, SoC 1100 also includes an L2 cache control 1104, a GPU 1106, a video codec 1108, a liquid crystal display (LCD) I/F 1110 and an interconnect 1112. L2 cache control 1104 can include a bus interface unit 1114, a L2 cache 1116. Liquid crystal display (LCD) I/F 1110 may be associated with mobile industry processor interface (MIPI)/HDMI links that couple to an LCD.

SoC 1100 may also include a subscriber identity module (SIM) I/F 1118, a boot ROM 1120, a synchronous dynamic random access memory (SDRAM) controller 1122, a flash controller 1124, a serial peripheral interface (SPI) director 1128, a suitable power control 1130, a dynamic RAM (DRAM) 1132, and flash 1134. In addition, one or more embodiments include one or more communication capabilities, interfaces, and features such as instances of Bluetooth, a 3G modem, a global positioning system (GPS), and an 802.11 Wi-Fi.

Designers of integrated circuits such as SoC 1100 (or other integrated circuits) may use intellectual property blocks (IP blocks) to simplify system design. An IP block is a modular, self-contained hardware block that can be easily integrated into the design. Because the IP block is modular and self-contained, the integrated circuit (IC) designer need only “drop in” the IP block to use the functionality of the IP block. The system designer can then make the appropriate connections to inputs and outputs.

IP blocks are often “black boxes.” In other words, the system integrator using the IP block may not know, and need not know, the specific implementation details of the IP block. Indeed, IP blocks may be provided as proprietary third-party units, with no insight into the design of the IP block by the system integrator.

For example, a system integrator designing an SoC for a smart phone may use IP blocks in addition to the processor core, such as a memory controller, a nonvolatile memory (NVM) controller, Wi-Fi, Bluetooth, GPS, a fourth or fifth-generation network (4G or 5G), an audio processor, a video processor, an image processor, a graphics engine, a GPU engine, a security controller, and many other IP blocks. In many cases, each of these IP blocks has its own embedded microcontroller.

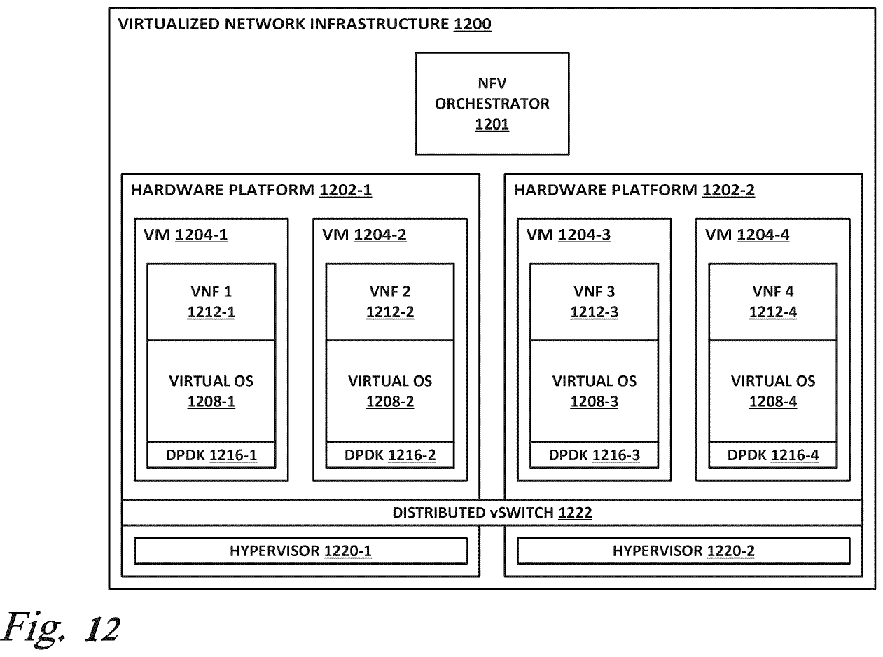

FIG. 12 is a block diagram of a NFV infrastructure 1200. NFV is an example of virtualization, and the virtualization infrastructure here can also be used to realize traditional VMs. Various functions described above may be realized as VMs, particularly some or all functions associated with back-end detection of fraudulent calls and call phases.

NFV is generally considered distinct from software defined networking (SDN), but they can interoperate together, and the teachings of this specification should also be understood to apply to SDN in appropriate circumstances. For example, virtual network functions (VNFs) may operate within the data plane of an SDN deployment. NFV was originally envisioned as a method for providing reduced capital expenditure (Capex) and operating expenses (Opex) for telecommunication services. One feature of NFV is replacing proprietary, special-purpose hardware appliances with virtual appliances running on commercial off-the-shelf (COTS) hardware within a virtualized environment. In addition to Capex and Opex savings, NFV provides a more agile and adaptable network. As network loads change, VNFs can be provisioned (“spun up”) or removed (“spun down”) to meet network demands. For example, in times of high load, more load balancing VNFs may be spun up to distribute traffic to more workload servers (which may themselves be VMs). In times when more suspicious traffic is experienced, additional firewalls or deep packet inspection (DPI) appliances may be needed.

Because NFV started out as a telecommunications feature, many NFV instances are focused on telecommunications. However, NFV is not limited to telecommunication services. In a broad sense, NFV includes one or more VNFs running within a network function virtualization infrastructure (NFVI), such as NFVI 1200. Often, the VNFs are inline service functions that are separate from workload servers or other nodes. These VNFs can be chained together into a service chain, which may be defined by a virtual subnetwork, and which may include a serial string of network services that provide behind-the-scenes work, such as security, logging, billing, and similar.

In the example of FIG. 12, an NFV orchestrator 1201 may manage several VNFs 1212 running on an NFVI 1200. NFV requires nontrivial resource management, such as allocating a very large pool of compute resources among appropriate numbers of instances of each VNF, managing connections between VNFs, determining how many instances of each VNF to allocate, and managing memory, storage, and network connections. This may require complex software management, thus making NFV orchestrator 1201 a valuable system resource. Note that NFV orchestrator 1201 may provide a browser-based or graphical configuration interface, and in some embodiments may be integrated with SDN orchestration functions.

Note that NFV orchestrator 1201 itself may be virtualized (rather than a special-purpose hardware appliance). NFV orchestrator 1201 may be integrated within an existing SDN system, wherein an operations support system (OSS) manages the SDN. This may interact with cloud resource management systems (e.g., OpenStack) to provide NFV orchestration. An NFVI 1200 may include the hardware, software, and other infrastructure to enable VNFs to run. This may include a hardware platform 1202 on which one or more VMs 1204 may run. For example, hardware platform 1202-1 in this example runs VMs 1204-1 and 1204-2. Hardware platform 1202-2 runs VMs 1204-3 and 1204-4. Each hardware platform 1202 may include a respective hypervisor 1220, virtual machine manager (VMM), or similar function, which may include and run on a native (bare metal) operating system, which may be minimal so as to consume very few resources. For example, hardware platform 1202-1 has hypervisor 1220-1, and hardware platform 1202-2 has hypervisor 1220-2.

Hardware platforms 1202 may be or comprise a rack or several racks of blade or slot servers (including, e.g., processors, memory, and storage), one or more data centers, other hardware resources distributed across one or more geographic locations, hardware switches, or network interfaces. An NFVI 1200 may also include the software architecture that enables hypervisors to run and be managed by NFV orchestrator 1201.

Running on NFVI 1200 are VMs 1204, each of which in this example is a VNF providing a virtual service appliance. Each VM 1204 in this example includes an instance of the Data Plane Development Kit (DPDK) 1216, a virtual operating system 1208, and an application providing the VNF 1212. For example, VM 1204-1 has virtual OS 1208-1, DPDK 1216-1, and VNF 1212-1. VM 1204-2 has virtual OS 1208-2, DPDK 1216-2, and VNF 1212-2. VM 1204-3 has virtual OS 1208-3, DPDK 1216-3, and VNF 1212-3. VM 1204-4 has virtual OS 1208-4, DPDK 1216-4, and VNF 1212-4.

Virtualized network functions could include, as nonlimiting and illustrative examples, firewalls, intrusion detection systems, load balancers, routers, session border controllers, DPI services, network address translation (NAT) modules, or call security association.

The illustration of FIG. 12 shows that a number of VNFs 1204 have been provisioned and exist within NFVI 1200. This FIGURE does not necessarily illustrate any relationship between the VNFs and the larger network, or the packet flows that NFVI 1200 may employ.

The illustrated DPDK instances 1216 provide a set of highly-optimized libraries for communicating across a virtual switch (vSwitch) 1222. Like VMs 1204, vSwitch 1222 is provisioned and allocated by a hypervisor 1220. The hypervisor uses a network interface to connect the hardware platform to the data center fabric (e.g., a host fabric interface (HFI)). This HFI may be shared by all VMs 1204 running on a hardware platform 1202. Thus, a vSwitch may be allocated to switch traffic between VMs 1204. The vSwitch may be a pure software vSwitch (e.g., a shared memory vSwitch), which may be optimized so that data are not moved between memory locations, but rather, the data may stay in one place, and pointers may be passed between VMs 1204 to simulate data moving between ingress and egress ports of the vSwitch. The vSwitch may also include a hardware driver (e.g., a hardware network interface IP block that switches traffic, but that connects to virtual ports rather than physical ports). In this illustration, a distributed vSwitch 1222 is illustrated, wherein vSwitch 1222 is shared between two or more physical hardware platforms 1202.

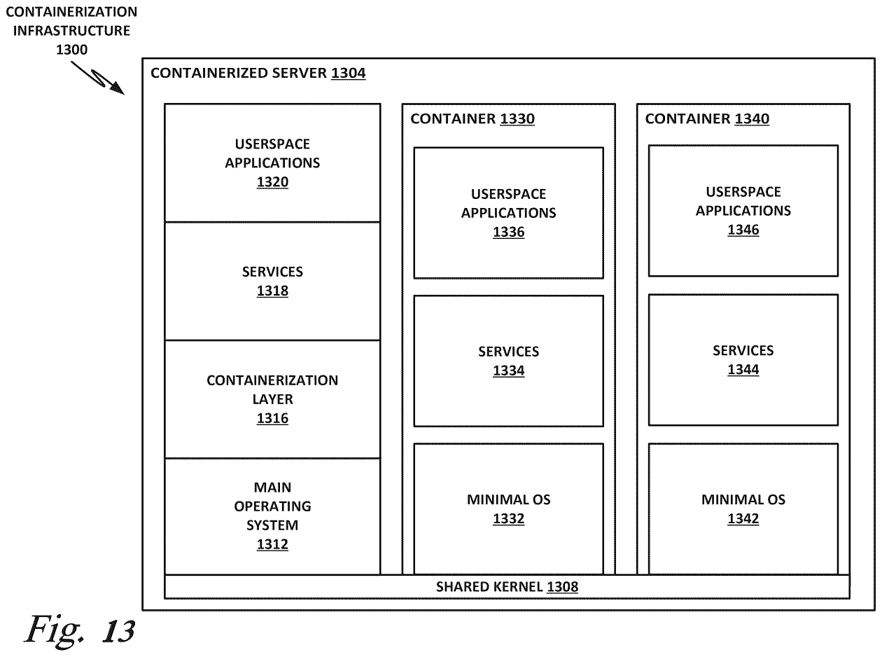

FIG. 13 is a block diagram of selected elements of a containerization infrastructure 1300. Like virtualization, containerization is a popular form of providing a guest infrastructure. Various functions described herein may be containerized, such as particularly some or all functions associated with back-end detection of fraudulent calls and call phases.

Containerization infrastructure 1300 runs on a hardware platform such as containerized server 1304. Containerized server 1304 may provide processors, memory, one or more network interfaces, accelerators, and/or other hardware resources.

Running on containerized server 1304 is a shared kernel 1308. One distinction between containerization and virtualization is that containers run on a common kernel with the main operating system and with each other. In contrast, in virtualization, the processor and other hardware resources are abstracted or virtualized, and each virtual machine provides its own kernel on the virtualized hardware.

Running on shared kernel 1308 is main operating system 1312. Commonly, main operating system 1312 is a Unix or Linux-based operating system, although containerization infrastructure is also available for other types of systems, including Microsoft Windows systems and Macintosh systems. Running on top of main operating system 1312 is a containerization layer 1316. For example, Docker is a popular containerization layer that runs on a number of operating systems, and relies on the Docker daemon. Newer operating systems (including Fedora Linux 32 and later) that use version 2 of the kernel control groups service (cgroups v2) feature appear to be incompatible with the Docker daemon. Thus, these systems may run with an alternative known as Podman that provides a containerization layer without a daemon.

Various factions debate the advantages and/or disadvantages of using a daemon-based containerization layer (e.g., Docker) versus one without a daemon (e.g., Podman). Such debates are outside the scope of the present specification, and when the present specification speaks of containerization, it is intended to include any containerization layer, whether it requires the use of a daemon or not.

Main operating system 1312 may also provide services 1318, which provide services and interprocess communication to userspace applications 1320.

Services 1318 and userspace applications 1320 in this illustration are independent of any container.

As discussed above, a difference between containerization and virtualization is that containerization relies on a shared kernel. However, to maintain virtualization-like segregation, containers do not share interprocess communications, services, or many other resources. Some sharing of resources between containers can be approximated by permitting containers to map their internal file systems to a common mount point on the external file system. Because containers have a shared kernel with the main operating system 1312, they inherit the same file and resource access permissions as those provided by shared kernel 1308. For example, one popular application for containers is to run a plurality of web servers on the same physical hardware. The Docker daemon provides a shared socket, docker.sock, that is accessible by containers running under the same Docker daemon. Thus, one container can be configured to provide only a reverse proxy for mapping hypertext transfer protocol (HTTP) and hypertext transfer protocol secure (HTTPS) requests to various containers. This reverse proxy container can listen on docker.sock for newly spun up containers. When a container spins up that meets certain criteria, such as by specifying a listening port and/or virtual host, the reverse proxy can map HTTP or HTTPS requests to the specified virtual host to the designated virtual port. Thus, only the reverse proxy host may listen on ports 80 and 443, and any request to subdomain1.example.com may be directed to a virtual port on a first container, while requests to subdomain2.example.com may be directed to a virtual port on a second container.

Other than this limited sharing of files or resources, which generally is explicitly configured by an administrator of containerized server 1304, the containers themselves are completely isolated from one another. However, because they share the same kernel, it is relatively easier to dynamically allocate compute resources such as CPU time and memory to the various containers. Furthermore, it is common practice to provide only a minimum set of services on a specific container, and the container does not need to include a full bootstrap loader because it shares the kernel with a containerization host (i.e. containerized server 1304).

Thus, “spinning up” a container is often relatively faster than spinning up a new virtual machine that provides a similar service. Furthermore, a containerization host does not need to virtualize hardware resources, so containers access those resources natively and directly. While this provides some theoretical advantages over virtualization, modern hypervisors—especially type 1, or “bare metal,” hypervisors—provide such near-native performance that this advantage may not always be realized.

In this example, containerized server 1304 hosts two containers, namely container 1330 and container 1340.

Container 1330 may include a minimal operating system 1332 that runs on top of shared kernel 1308. Note that a minimal operating system is provided as an illustrative example, and is not mandatory. In fact, container 1330 may perform as full an operating system as is necessary or desirable. Minimal operating system 1332 is used here as an example simply to illustrate that in common practice, the minimal operating system necessary to support the function of the container (which in common practice, is a single or monolithic function) is provided.

On top of minimal operating system 1332, container 1330 may provide one or more services 1334. Finally, on top of services 1334, container 1330 may also provide userspace applications 1336, as necessary.

Container 1340 may include a minimal operating system 1342 that runs on top of shared kernel 1308. Note that a minimal operating system is provided as an illustrative example, and is not mandatory. In fact, container 1340 may perform as full an operating system as is necessary or desirable. Minimal operating system 1342 is used here as an example simply to illustrate that in common practice, the minimal operating system necessary to support the function of the container (which in common practice, is a single or monolithic function) is provided.

On top of minimal operating system 1342, container 1340 may provide one or more services 1344. Finally, on top of services 1344, container 1340 may also provide userspace applications 1346, as necessary.

Using containerization layer 1316, containerized server 1304 may run discrete containers, each one providing the minimal operating system and/or services necessary to provide a particular function. For example, containerized server 1304 could include a mail server, a web server, a secure shell server, a file server, a weblog, cron services, a database server, and many other types of services. In theory, these could all be provided in a single container, but security and modularity advantages are realized by providing each of these discrete functions in a discrete container with its own minimal operating system necessary to provide those services.

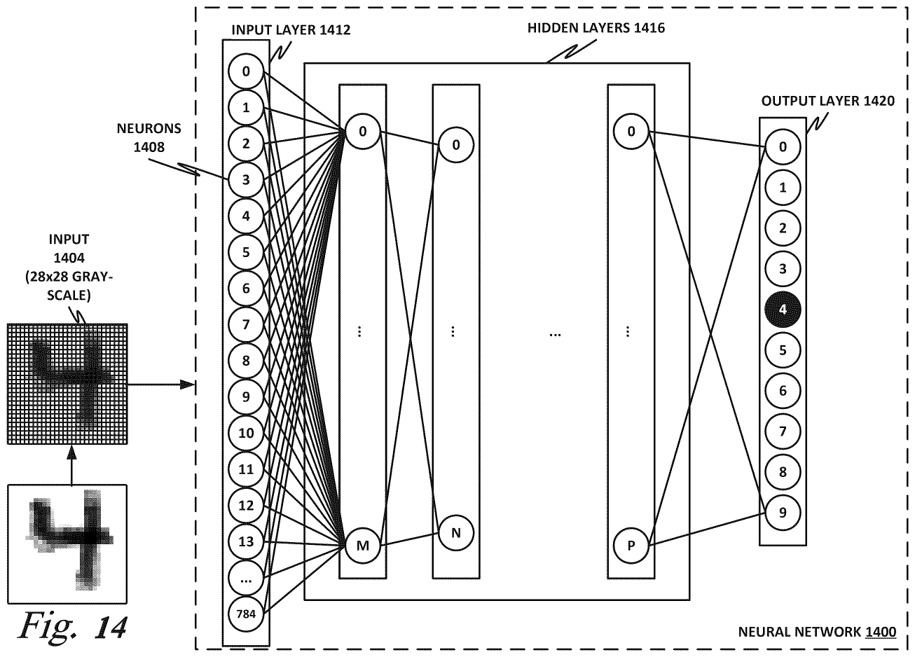

FIG. 14 illustrates selected elements of an artificial intelligence system or architecture. In this FIGURE, an elementary neural network is used as a representative embodiment of an artificial intelligence or machine learning architecture or engine. This should be understood to be a nonlimiting example, and other machine learning or artificial intelligence architectures are available, including for example symbolic learning, robotics, computer vision, pattern recognition, statistical learning, speech recognition, natural language processing, deep learning, convolutional neural networks, recurrent neural networks, object recognition and/or others. This FIGURE and its associated description are not intended to provide an exhaustive disclosure of every aspect of AI, but rather to provide a baseline vocabulary, both literal and conceptual, for discussing AI concepts.

FIG. 14 illustrates machine learning according to a “textbook” problem with real-world applications. In this case, a neural network 1400 is tasked with recognizing characters. To simplify the description, neural network 1400 is tasked only with recognizing single digits in the range of 0 through 9. These are provided as an input image 1404. In this example, input image 1404 is a 28×28-pixel 8-bit grayscale image. In other words, input image 1404 is a square that is 28 pixels wide and 28 pixels high. Each pixel has a value between 0 and 255, with 0 representing white or no color, and 255 representing black or full color, with values in between representing various shades of gray. This provides a straightforward problem space to illustrate the operative principles of a neural network. Only selected elements of neural network 1400 are illustrated in this FIGURE, and that real-world applications may be more complex, and may include additional features, such as the use of multiple channels (e.g., for a color image, there may be three distinct channels for red, green, and blue). Additional layers of complexity or functions may be provided in a neural network, or other artificial intelligence architecture, to meet the demands of a particular problem. Indeed, the architecture here is sometimes referred to as the “Hello World” problem of machine learning, and is provided as but one example of how the machine learning or artificial intelligence functions of the present specification could be implemented.

In this case, neural network 1400 includes an input layer 1412 and an output layer 1420. In principle, input layer 1412 receives an input such as input image 1404, and at output layer 1420, neural network 1400 “lights up” a perceptron that indicates which character neural network 1400 thinks is represented by input image 1404.

Between input layer 1412 and output layer 1420 are some number of hidden layers 1416. The number of hidden layers 1416 will depend on the problem to be solved, the available compute resources, and other design factors. In general, the more hidden layers 1416, and the more neurons per hidden layer, the more accurate the neural network 1400 may become. However, adding hidden layers and neurons also increases the complexity of the neural network, and its demand on compute resources. Thus, some design skill is required to determine the appropriate number of hidden layers 1416, and how many neurons are to be represented in each hidden layer 1416.

Input layer 1412 includes, in this example, 784 “neurons” 1408. Each neuron of input layer 1412 receives information from a single pixel of input image 1404. Because input image 1404 is a 28×28 grayscale image, it has 784 pixels. Thus, each neuron in input layer 1412 holds 8 bits of information, taken from a pixel of input layer 1404. This 8-bit value is the “activation” value for that neuron.

Each neuron in input layer 1412 has a connection to each neuron in the first hidden layer in the network. In this example, the first hidden layer has neurons labeled 0 through M. Each of the M+1 neurons is connected to all 784 neurons in input layer 1412. Each neuron in hidden layer 1416 includes a kernel or transfer function, which is described in greater detail below. The kernel or transfer function determines how much “weight” to assign each connection from input layer 1412. In other words, a neuron in hidden layer 1416 may think that some pixels are more important to its function than other pixels. Based on this transfer function, each neuron computes an activation value for itself, which may be for example a decimal number between 0 and 1.

A common operation for the kernel is convolution, in which case the neural network may be referred to as a “convolutional neural network” (CNN). The case of a network with multiple hidden layers between the input layer and output layer may be referred to as a “deep neural network” (DNN). A DNN may be a CNN, and a CNN may be a DNN, but neither expressly implies the other.

Each neuron in this layer is also connected to each neuron in the next layer, which has neurons from 0 to N. As in the previous layer, each neuron has a transfer function that assigns a particular weight to each of its M+1 connections and computes its own activation value. In this manner, values are propagated along hidden layers 1416, until they reach the last layer, which has P+1 neurons labeled 0 through P. Each of these P+1 neurons has a connection to each neuron in output layer 1420. Output layer 1420 includes a number of neurons known as perceptrons that compute an activation value based on their weighted connections to each neuron in the last hidden layer 1416. The final activation value computed at output layer 1420 may be thought of as a “probability” that input image 1404 is the value represented by the perceptron. For example, if neural network 1400 operates perfectly, then perceptron 4 would have a value of 1.00, while each other perceptron would have a value of 0.00. This would represent a theoretically perfect detection. In practice, detection is not generally expected to be perfect, but it is desirable for perceptron 4 to have a value close to 1, while the other perceptrons have a value close to 0.

Conceptually, neurons in the hidden layers 1416 may correspond to “features.” For example, in the case of computer vision, the task of recognizing a character may be divided into recognizing features such as the loops, lines, curves, or other features that make up the character. Recognizing each loop, line, curve, etc., may be further divided into recognizing smaller elements (e.g., line or curve segments) that make up that feature. Moving through the hidden layers from left to right, it is often expected and desired that each layer recognizes the “building blocks” that make up the features for the next layer. In practice, realizing this effect is itself a nontrivial problem, and may require greater sophistication in programming and training than is fairly represented in this simplified example.

The activation value for neurons in the input layer is simply the value taken from the corresponding pixel in the bitmap. The activation value (a) for each neuron in succeeding layers is computed according to a transfer function, which accounts for the “strength” of each of its connections to each neuron in the previous layer. The transfer can be written as a sum of weighted inputs (i.e., the activation value (a) received from each neuron in the previous layer, multiplied by a weight representing the strength of the neuron-to-neuron connection (w)), plus a bias value.

The weights may be used, for example, to “select” a region of interest in the pixmap that corresponds to a “feature” that the neuron represents. Positive weights may be used to select the region, with a higher positive magnitude representing a greater probability that a pixel in that region (if the activation value comes from the input layer) or a subfeature (if the activation value comes from a hidden layer) corresponds to the feature. Negative weights may be used for example to actively “de-select” surrounding areas or subfeatures (e.g., to mask out lighter values on the edge), which may be used for example to clean up noise on the edge of the feature. Pixels or subfeatures far removed from the feature may have for example a weight of zero, meaning those pixels should not contribute to examination of the feature.

The bias (b) may be used to set a “threshold” for detecting the feature. For example, a large negative bias indicates that the “feature” should be detected only if it is strongly detected, while a large positive bias makes the feature much easier to detect.

The biased weighted sum yields a number with an arbitrary sign and magnitude. This real number can then be normalized to a final value between 0 and 1, representing (conceptually) a probability that the feature this neuron represents was detected from the inputs received from the previous layer. Normalization may include a function such as a step function, a sigmoid, a piecewise linear function, a Gaussian distribution, a linear function or regression, or the popular “rectified linear unit” (ReLU) function. In the examples of this specification, a sigmoid function notation (σ) is used by way of illustrative example, but it should be understood to stand for any normalization function or algorithm used to compute a final activation value in a neural network.

The transfer function for each neuron in a layer yields a scalar value. For example, the activation value for neuron “0” in layer “1” (the first hidden layer), may be written as:

$${a}_{0}^{( 1 )} = σ ( {w}_{0} {a}_{0}^{( 0 )} + {w}_{1} {a}_{1}^{( 0 )} + ⋯ {w}_{783} {a}_{783}^{( 0 )} + b )$$

In this case, it is assumed that layer 0 (input layer 1412) has 784 neurons. Where the previous layer has “n” neurons, the function can be generalized as:

$${a}_{0}^{( 1 )} = σ ( {w}_{0} {a}_{0}^{( 0 )} + {w}_{1} {a}_{1}^{( 0 )} + ⋯ {w}_{n} {a}_{n}^{( 0 )} + b )$$

A similar function is used to compute the activation value of each neuron in layer 1 (the first hidden layer), weighted with that neuron's strength of connections to each neuron in layer 0, and biased with some threshold value. As discussed above, the sigmoid function shown here is intended to stand for any function that normalizes the output to a value between 0 and 1.

The full transfer function for layer 1 (with k neurons in layer 1) may be written in matrix notation as:

$${a}^{( 1 )} = σ ( [ \begin{matrix}{w}_{0 , 0} & ⋯ & {w}_{0 , n} \\ ⋮ & ⋱ & ⋮ \\ {w}_{( k , 0 )} & ⋯ & {w}_{k , n}\end{matrix} ] [ \begin{matrix}{a}_{0}^{( 0 )} \\ ⋮ \\ {a}_{0}^{( 0 )}\end{matrix} ] + [ \begin{matrix}{b}_{0} \\ ⋮ \\ {b}_{n}\end{matrix} ] )$$

More compactly, the full transfer function for layer 1 can be written in vector notation as:

$${a}^{( 1 )} = σ ( {Wa}^{( 0 )} + b )$$

Neural connections and activation values are propagated throughout the hidden layers 1416 of the network in this way, until the network reaches output layer 1420. At output layer 1420, each neuron is a “bucket” or classification, with the activation value representing a probability that the input object should be classified to that perceptron. The classifications may be mutually exclusive or multinominal. For example, in the computer vision example of character recognition, a character may best be assigned only one value, or in other words, a single character is not expected to be simultaneously both a “4” and a “9.” In that case, the neurons in output layer 1420 are binomial perceptrons. Ideally, only one value is above the threshold, causing the perceptron to metaphorically “light up,” and that value is selected. In the case where multiple perceptrons light up, the one with the highest probability may be selected. The result is that only one value (in this case, “4”) should be lit up, while the rest should be “dark.” Indeed, if the neural network were theoretically perfect, the “4” neuron would have an activation value of 1.00, while each other neuron would have an activation value of 0.00.

In the case of multinominal perceptrons, more than one output may be lit up. For example, a neural network may determine that a particular document has high activation values for perceptrons corresponding to several departments, such as Accounting, Information Technology (IT), and Human Resources. On the other hand, the activation values for perceptrons for Legal, Manufacturing, and Shipping are low. In the case of multinominal classification, a threshold may be defined, and any neuron in the output layer with a probability above the threshold may be considered a “match” (e.g., the document is relevant to those departments). Those below the threshold are considered not a match (e.g., the document is not relevant to those departments).

The weights and biases of the neural network act as parameters, or “controls,” wherein features in a previous layer are detected and recognized. When the neural network is first initialized, the weights and biases may be assigned randomly or pseudo-randomly. Thus, because the weights-and-biases controls are garbage, the initial output is expected to be garbage. In the case of a “supervised” learning algorithm, the network is refined by providing a “training” set, which includes objects with known results. Because the correct answer for each object is known, training sets can be used to iteratively move the weights and biases away from garbage values, and toward more useful values.

A common method for refining values includes “gradient descent” and “back-propagation.” An illustrative gradient descent method includes computing a “cost” function, which measures the error in the network. For example, in the illustration, the “4” perceptron ideally has a value of “1.00,” while the other perceptrons have an ideal value of “0.00.” The cost function takes the difference between each output and its ideal value, squares the difference, and then takes a sum of all of the differences. Each training example will have its own computed cost. Initially, the cost function is very large, because the network does not know how to classify objects. As the network is trained and refined, the cost function value is expected to get smaller, as the weights and biases are adjusted toward more useful values.

With, for example, 100,000 training examples in play, an average cost (e.g., a mathematical mean) can be computed across all 100,00 training examples. This average cost provides a quantitative measurement of how “badly” the neural network is doing its detection job.

The cost function can thus be thought of as a single, very complicated formula, where the inputs are the parameters (weights and biases) of the network. Because the network may have thousands or even millions of parameters, the cost function has thousands or millions of input variables. The output is a single value representing a quantitative measurement of the error of the network. The cost function can be represented as:

$$C ( w )$$

Wherein w is a vector containing all of the parameters (weights and biases) in the network. The minimum (absolute and/or local) can then be represented as a trivial calculus problem, namely:

$$\frac{dC}{dw} ( w ) = 0$$

Solving such a problem symbolically may be prohibitive, and in some cases not even possible, even with heavy computing power available. Rather, neural networks commonly solve the minimizing problem numerically. For example, the network can compute the slope of the cost function at any given point, and then shift by some small amount depending on whether the slope is positive or negative. The magnitude of the adjustment may depend on the magnitude of the slope. For example, when the slope is large, it is expected that the local minimum is “far away,” so larger adjustments are made. As the slope lessens, smaller adjustments are made to avoid badly overshooting the local minimum. In terms of multi-vector calculus, this is a gradient function of many variables:

$$- ∇ C ( w )$$

The value of −∇C is simply a vector of the same number of variables as w, indicating which direction is “down” for this multivariable cost function. For each value in −∇C, the sign of each scalar tells the network which “direction” the value needs to be nudged, and the magnitude of each scalar can be used to infer which values are most “important” to change.

Gradient descent involves computing the gradient function, taking a small step in the “downhill” direction of the gradient (with the magnitude of the step depending on the magnitude of the gradient), and then repeating until a local minimum has been found within a threshold.

While finding a local minimum is relatively straightforward once the value of −∇C, finding an absolute minimum is many times harder, particularly when the function has thousands or millions of variables. Thus, common neural networks consider a local minimum to be “good enough,” with adjustments possible if the local minimum yields unacceptable results. Because the cost function is ultimately an average error value over the entire training set, minimizing the cost function yields a (locally) lowest average error.

In many cases, the most difficult part of gradient descent is computing the value of −∇C. As mentioned above, computing this symbolically or exactly would be prohibitively difficult. A more practical method is to use back-propagation to numerically approximate a value for −∇C. Back-propagation may include, for example, examining an individual perceptron at the output layer, and determining an average cost value for that perceptron across the whole training set. Taking the “4” perceptron as an example, if the input image is a 4, it is desirable for the perceptron to have a value of 1.00, and for any input images that are not a 4, it is desirable to have a value of 0.00. Thus, an overall or average desired adjustment for the “4” perceptron can be computed.

However, the perceptron value is not hard-coded, but rather depends on the activation values received from the previous layer. The parameters of the perceptron itself (weights and bias) can be adjusted, but it may also be desirable to receive different activation values from the previous layer. For example, where larger activation values are received from the previous layer, the weight is multiplied by a larger value, and thus has a larger effect on the final activation value of the perceptron. The perceptron metaphorically “wishes” that certain activations from the previous layer were larger or smaller. Those wishes can be back-propagated to the previous layer neurons.

At the next layer, the neuron accounts for the wishes from the next downstream layer in determining its own preferred activation value. Again, at this layer, the activation values are not hard-coded. Each neuron can adjust its own weights and biases, and then back-propagate changes to the activation values that it wishes would occur. The back-propagation continues, layer by layer, until the weights and biases of the first hidden layer are set. This layer cannot back-propagate desired changes to the input layer, because the input layer receives activation values directly from the input image.

After a round of such nudging, the network may receive another round of training with the same or a different training data set, and the process is repeated until a local and/or global minimum value is found for the cost functions.

The foregoing outlines features of several embodiments so that those skilled in the art may better understand various aspects of the present disclosure. The foregoing detailed description sets forth examples of apparatuses, methods, and systems relating to a system for providing a user warning for fraudulent call phases, in accordance with one or more embodiments of the present disclosure. Features such as structure(s), function(s), and/or characteristic(s), for example, are described with reference to one embodiment as a matter of convenience; various embodiments may be implemented with any suitable one or more of the described features.

As used throughout this specification, the phrase “an embodiment” is intended to refer to one or more embodiments. Furthermore, different uses of the phrase “an embodiment” may refer to different embodiments. The phrases “in another embodiment” or “in a different embodiment” refer to an embodiment different from the one previously described, or the same embodiment with additional features. For example, “in an embodiment, features may be present. In another embodiment, additional features may be present.” The foregoing example could first refer to an embodiment with features A, B, and C, while the second could refer to an embodiment with features A, B, C, and D, with features, A, B, and D, with features, D, E, and F, or any other variation.

In the foregoing description, various aspects of the illustrative implementations may be described using terms commonly employed by those skilled in the art to convey the substance of their work to others skilled in the art. It will be apparent to those skilled in the art that the embodiments disclosed herein may be practiced with only some of the described aspects. For purposes of explanation, specific numbers, materials, and configurations are set forth to provide a thorough understanding of the illustrative implementations. In some cases, the embodiments disclosed may be practiced without specific details. In other instances, well-known features are omitted or simplified so as not to obscure the illustrated embodiments.

For the purposes of the present disclosure and the appended claims, the article “a” refers to one or more of an item. The phrase “A or B” is intended to encompass the “inclusive or,” e.g., A, B, or (A and B). “A and/or B” means A, B, or (A and B). For the purposes of the present disclosure, the phrase “A, B, and/or C” means A, B, C, (A and B), (A and C), (B and C), or (A, B, and C).

The embodiments disclosed can readily be used as the basis for designing or modifying other processes and structures to carry out the teachings of the present specification. Any equivalent constructions to those disclosed do not depart from the spirit and scope of the present disclosure. Design considerations may result in substitute arrangements, design choices, device possibilities, hardware configurations, software implementations, and equipment options.

As used throughout this specification, a “memory” is expressly intended to include both a volatile memory and a nonvolatile memory. Thus, for example, an “engine” as described above could include instructions encoded within a volatile or nonvolatile memory that, when executed, instruct a processor to perform the operations of any of the methods or procedures disclosed herein. It is expressly intended that this configuration reads on a computing apparatus “sitting on a shelf” in a non-operational state. For example, in this example, the “memory” could include one or more tangible, nontransitory computer-readable storage media that contain stored instructions. These instructions, in conjunction with the hardware platform (including a processor) on which they are stored may constitute a computing apparatus.

In other embodiments, a computing apparatus may also read on an operating device. For example, in this configuration, the “memory” could include a volatile or run-time memory (e.g., RAM), where instructions have already been loaded. These instructions, when fetched by the processor and executed, may provide methods or procedures as described herein.

In yet another embodiment, there may be one or more tangible, nontransitory computer-readable storage media having stored thereon executable instructions that, when executed, cause a hardware platform or other computing system, to carry out a method or procedure. For example, the instructions could be executable object code, including software instructions executable by a processor. The one or more tangible, nontransitory computer-readable storage media could include, by way of illustrative and nonlimiting example, a magnetic media (e.g., hard drive), a flash memory, a ROM, optical media (e.g., CD, DVD, Blu-Ray), nonvolatile random-access memory (NVRAM), nonvolatile memory (NVM) (e.g., Intel 3D Xpoint), or other nontransitory memory.

There are also provided herein certain methods, illustrated for example in flow charts and/or signal flow diagrams. The order or operations disclosed in these methods discloses one illustrative ordering that may be used in some embodiments, but this ordering is not intended to be restrictive, unless expressly stated otherwise. In other embodiments, the operations may be carried out in other logical orders. In general, one operation should be deemed to necessarily precede another only if the first operation provides a result required for the second operation to execute. Furthermore, the sequence of operations itself should be understood to be a nonlimiting example. In appropriate embodiments, some operations may be omitted as unnecessary or undesirable. In the same or in different embodiments, other operations not shown may be included in the method to provide additional results.

In certain embodiments, some of the components illustrated herein may be omitted or consolidated. In a general sense, the arrangements depicted in the FIGURES may be more logical in their representations, whereas a physical architecture may include various permutations, combinations, and/or hybrids of these elements.

With the numerous examples provided herein, interaction may be described in terms of two, three, four, or more electrical components. These descriptions are provided for purposes of clarity and example only. Any of the illustrated components, modules, and elements of the FIGURES may be combined in various configurations, all of which fall within the scope of this specification.

In certain cases, it may be easier to describe one or more functionalities by disclosing only selected elements. Such elements are selected to illustrate specific information to facilitate the description. The inclusion of an element in the FIGURES is not intended to imply that the element must appear in the disclosure, as claimed, and the exclusion of certain elements from the FIGURES is not intended to imply that the element is to be excluded from the disclosure as claimed. Similarly, any methods or flows illustrated herein are provided by way of illustration only. Inclusion or exclusion of operations in such methods or flows should be understood the same as inclusion or exclusion of other elements as described in this paragraph. Where operations are illustrated in a particular order, the order is a nonlimiting example only. Unless expressly specified, the order of operations may be altered to suit a particular embodiment.

Other changes, substitutions, variations, alterations, and modifications will be apparent to those skilled in the art. All such changes, substitutions, variations, alterations, and modifications fall within the scope of this specification.

To aid the United States Patent and Trademark Office (USPTO) and, any readers of any patent or publication flowing from this specification, the Applicant: (a) does not intend any of the appended claims to invoke paragraph (f) of 35 U.S.C. section 112, or its equivalent, as it exists on the date of the filing hereof unless the words “means for” or “steps for” are specifically used in the particular claims; and (b) does not intend, by any statement in the specification, to limit this disclosure in any way that is not otherwise expressly reflected in the appended claims, as originally presented or as amended.

1-66. (canceled)

67. One or more tangible, nontransitory computer-readable storage media having stored thereon executable instructions to instruct a processor to:
communicate with a backend analysis engine, wherein the backend analysis engine is to provide a periodically-updated assessment of a voice call, the assessment comprising an inferred call phase and a fraudulence score; and
provide a graphical user interface (GUI) visible to a participant of the voice call, wherein the GUI is to display the inferred call phase and a visual fraud indicator based on a likelihood that the voice call is fraudulent.

68. The one or more tangible, nontransitory computer-readable storage media of claim 67, wherein the visual fraud indicator comprises a percentage.

69. The one or more tangible, nontransitory computer-readable storage media of claim 67, wherein the visual fraud indicator comprises an A-F grade.

70. The one or more tangible, nontransitory computer-readable storage media of claim 67, wherein the visual fraud indicator comprises a quantized indication of low, medium, or high.

71. The one or more tangible, nontransitory computer-readable storage media of claim 67, wherein the visual fraud indicator comprises a color-coded indication.

72. The one or more tangible, nontransitory computer-readable storage media of claim 71, wherein the color-coded indication comprises green for safe, yellow for risky, and red for likely fraudulent.

73. The one or more tangible, nontransitory computer-readable storage media of claim 67, wherein the visual fraud indicator comprises a simulated analog meter.

74. The one or more tangible, nontransitory computer-readable storage media of claim 67, wherein the visual fraud indicator flashes a warning above a fraud likelihood threshold.

75. The one or more tangible, nontransitory computer-readable storage media of claim 74, wherein the fraud likelihood threshold is 70%.

76. The one or more tangible, nontransitory computer-readable storage media of claim 67, wherein the instructions are further to terminate the voice call above a fraud likelihood threshold.

77. The one or more tangible, nontransitory computer-readable storage media of claim 76, wherein the fraud likelihood threshold is 80%.

78. The one or more tangible, nontransitory computer-readable storage media of claim 67, wherein the instructions are further to provide an audible warning above a fraud likelihood threshold.

79. The one or more tangible, nontransitory computer-readable storage media of claim 78, wherein the audible warning is a shrill alarm.

80. The one or more tangible, nontransitory computer-readable storage media of claim 78, wherein the audible warning is a voice prompt that a fraudulent call has been detected.

81. The one or more tangible, nontransitory computer-readable storage media of claim 78, wherein the fraud likelihood threshold is between 70% and 80%.

82. A computer-implemented method of protecting a user of a device from fraudulent voice calls, comprising:
communicating with a backend analysis engine, wherein the backend analysis engine is to provide a periodically-updated assessment of a voice call, the assessment comprising an inferred call phase and a fraudulence score; and
providing a graphical user interface (GUI) visible to a participant of the voice call, wherein the GUI is to display the inferred call phase and a visual fraud indicator based on a likelihood that the voice call is fraudulent.

83. The computer-implemented method of claim 82, wherein the visual fraud indicator comprises a percentage and/or a simulated analog meter.

84. The computer-implemented method of claim 82, further comprising providing an audible warning or terminating the voice call above a fraud likelihood threshold.

85. A computing apparatus, comprising:
a hardware platform comprising a processor circuit and a memory; and
instructions encoded within the memory to instruct the processor circuit to:
communicate with a backend analysis engine, wherein the backend analysis engine is to provide a periodically-updated assessment of a voice call, the assessment comprising an inferred call phase and a fraudulence score; and
provide a graphical user interface (GUI) visible to a participant of the voice call, wherein the GUI is to display the inferred call phase and a visual fraud indicator based on a likelihood that the voice call is fraudulent.

86. The computing apparatus of claim 85, wherein the visual fraud indicator comprises a percentage.
